(19) United States
(12) Patent Application Publication
(10) Pub. No.: US 2004/0064447 A1
(43) Pub. Date: Apr. 1, 2004

(54) System and method for management of synonymic searching

(76) Inventors: Steven J. Simske, Fort Collins, CO (US); Igor M. Boyko, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 10/256,674

(22) Filed: Sep. 27, 2002

(51) Int. Cl. G06F 7/00

(52) U.S. Cl. 707/5

(57) ABSTRACT

A system and method for computerized searching for desired information from a corpus of information are provided. In one embodiment, a query for desired information is received by a synonymic search application. Also received is input tuning the amount of synonymic broadening to be applied to the received query for constructing a synonymic search query to be utilized for searching for the desired information. In another embodiment, a synonymic search application performs a synonymic search query for desired information from a corpus of information, wherein the synonymic search query comprises a plurality of queries that are synonymous in meaning. Identification of resulting documents responsive to each of the plurality of queries is received, and such received documents are ranked based at least in part on a weighting assigned to each of the plurality of queries.

### FIELD OF THE INVENTION

The present invention relates in general to computerized searching for desired information from a corpus of information, and more specifically to a system and method for management of synonymic searching.

### DESCRIPTION OF RELATED ART

Today, much information is stored as digital data that is retrievable by a computer. Once information is stored as digital data, techniques for searching the corpus of stored information for desired information become important in that such searching techniques often dictate whether a user is able to find desired information within the corpus of stored information. That is, the stored information is often valuable only to the extent that a user can find such information when desired. Accordingly, various techniques have been developed to aid a user in searching a corpus of stored data. For instance, data is commonly stored in a database, and techniques have been developed to enable a user to query the database for desired information. For example, Structured Query Language (“SQL”) is a language that is commonly used to develop queries for searching a database for desired information.

As society continues to evolve toward even greater dependence on computerized storage of information, proper tools for searching a corpus of such computerized information for desired information become even more important. For example, with the proliferation of client-server networks, such as the Internet, a user's computer (e.g., personal computer, cellular telephone, personal digital assistant, or other processor-based device) often has access to a seemingly infinite corpus of information. Of course, such corpus of information is valuable to the user only to the extent that the user is capable of finding within the corpus the information that the user desires.

Client-server networks are delivering a large array of information, including content (e g., informative articles, etc.) and services, such as personal shopping, airline reservations, rental car reservations, hotel reservations, on-line auctions, on-line banking, stock market trading, as well as many other services. Such information providers (sometimes referred to as “content providers”) are making an increasing amount of information (e.g., services, informative articles, etc.) available to users via client-server networks.

An abundance of information is available on client-server networks, such as the Internet or the World Wide Web (the “web”), and the amount of information available on such client-server networks is continuously increasing. So much information is available on client-server networks, such as the Internet, with so little organization of such information that it can often seem impossible to find the information that a user desires. Further, users are increasingly gaining access to client-server networks, such as the web, and commonly look to such client-server networks (as opposed to or in addition to other sources of information) for desired information. For example, a relatively large segment of the human population have access to the Internet via personal computers (PCs), and Internet access is now possible with many mobile devices, such as personal digital assistants (PDAs), cellular telephones, etc.

Just as various tools have been developed for aiding users in searching a locally-stored corpus of information (such as SQL search queries for searching a centralized database accessible to a computer), a number of solutions have sprung up to aid users in finding the information that they desire on a client-server network. The two most popular solutions utilized for the Internet, for example, are indexes and search engines, which are each described further below.

Indexes present a highly structured way to find information. They enable a user to browse through information by categories, such as arts, computers, entertainment, sports, and so on. In a web browser, a user selects a category (e.g., by clicking with a pointing device, such as a mouse, on the desired category from a list), and the user is then presented with a series of subcategories. Under sports, for example, such subcategories as baseball, basketball, football, hockey, and soccer may be provided. Depending on the size of the index, several layers of subcategories may be available. When the user gets to the subcategory in which he/she is interested, the user can be presented with a list of relevant documents. The user may then click a hypertext link to get to those documents that he/she would like to retrieve. YAHOO! (http://ww.yahoo.com/) provides a large and popular index on the Internet. YAHOO! also provides a search engine, such as those described further below, that enables a user to search by typing words that describe the information for which the user is looking.

Another popular way of finding information in a client-server network is to use search engines, also called webcrawlers or spiders. Search engines operate differently from indexes. They are essentially massive databases that cover wide swaths of the client-server network (typically the Internet). Search engines do not present information in a hierarchical fashion (e.g., as with the above-described categories and subcategories of indexes). Instead, a user searches through them in a manner similar to database searching, by typing keywords that describe the information that the user desires. Many popular Internet search engines exist, including GOOGLE, LYCOS, EXCITE, and ALTAVISTA.

Executing the same search query on different search engines may result in different documents being returned to the user. Also, different search engines may return results for a query in a different way. Some weigh (or prioritize) the results to show the relevance of the documents; some show the first several sentences of the document; and some show the title of the document as well as the Uniform Resource Locator (“URL”). Because of the relatively large number of documents within the corpus that may be identified by the search engine as satisfying a given query, search engines typically implement some type of document weighting scheme in an attempt to present the documents that are most likely relevant to the user's query first. Search engines typically weight documents based on trusted users of the search engine, i.e., documents accessed most often by “trusted users” are assigned higher weighting, click through rates of the documents, advertising support (i.e., the search engine's sponsors get higher weightings) and/or document self-reported keywords, as examples.

Often, traditional search techniques fail to find information (e.g., websites) that are desired by a user. Such traditional searching techniques are generally limited by the user's ability to craft a suitable search query. For example, a user that is unfamiliar with a particular topic may have only a vague idea of the terminology to use in developing a search query for information relating to the topic. Thus, the user may not be sufficiently familiar with a topic to use the proper terminology in his/her search query to uncover documents in the corpus being searched that are related to the topic. As another example, if the user uses a different term in his/her search query to describe a particular idea than the author(s) of documents within the corpus use to describe such idea, then the user's query will fail to uncover those relevant documents because the user failed to craft his/her search query in the same terminology as used by the author(s) of the relevant documents. For instance, if a user uses a particular term (e.g., “class”) in his/her search query in searching a corpus for desired information, and if many of the documents within the corpus use a different term to describe the same idea (e.g., “division” rather than “class”), then the user's search query will fail to uncover these relevant documents because the user and the author(s) of the documents use different terms to describe the same idea.

Given the flexibility of human language, many ideas can be expressed through the use of different words. That is, many words are substantially interchangeable in conveying a particular idea (e.g., the words are “synonyms”). Accordingly, difficulty often arises in a user crafting a suitable search query that uncovers relevant documents within a corpus. Recent proposals have been made for searching techniques that utilize synonymic searching. That is, searching techniques have been proposed that effectively broaden a user's search query to include synonyms of terms provided by the user in such search query.

### BRIEF SUMMARY OF THE INVENTION

According to one embodiment of the present invention, a method for computerized searching for desired information from a corpus of information is provided. The method comprises receiving a search query for desired information, and receiving input tuning the amount of synonymic broadening to be applied to the received search query for constructing a synonymic search query to be utilized for searching for the desired information.

According to another embodiment of the present invention, computer-executable software code stored on a computer-readable medium is provided. The computer-executable software code comprises code for presenting a user-interface that enables a user to tune an amount of synonymic broadening to be applied to an input query. The computer-executable software code further comprises code responsive to received tuning input for generating a synonymic search query having a desired breadth for searching a corpus of information for desired information.

According to another embodiment of the present invention, a system is provided for generating a synonymic search query for searching for desired information from a corpus of information. The system comprises a means for receiving a query for desired information, and a means for determining at least one synonymic query that is synonymous in meaning with the received query. The system further comprises a means for receiving input tuning a number (Q) of synonymic queries to be included in a constructed synonymic search query, and a means for constructing a synonymic search query having Q number of synonymic queries.

According to still another embodiment of the present invention, a method for computerized searching for desired information from a corpus of information is provided. The method comprises performing a synonymic search query for desired information from a corpus of information, wherein such synonymic search query comprises a plurality of queries that are synonymous in meaning. The method further comprises receiving identification of resulting documents responsive to each of the plurality of queries, and ranking the received documents based at least in part on a weighting assigned to each of the plurality of queries.

According to yet another embodiment of the present invention, computer-executable software code stored on a computer-readable medium is provided, which comprises code for performing a synonymic search query for desired information from a corpus of information, wherein such synonymic search query comprises a plurality of queries that are synonymous in meaning. The computer-executable software code further comprises code for receiving identification of resulting documents responsive to each of the plurality of queries, and code for ranking the received documents based at least in part on a weighting assigned to each of the plurality of queries.

### BRIEF DESCRIPTION OF THE DRAWINGS

FIG. 1 shows an example client-server system of the prior art in which embodiments of the present invention may be implemented;

FIG. 2 shows an example of a traditional web search engine;

FIG. 3A shows an example operational flow for performing synonymic searching in accordance with an embodiment of the present invention;

FIG. 3B shows an example block diagram for the functionality of a synonymic search application;

FIG. 4A shows an example user interface of a synonymic search application in accordance with an embodiment of the present invention;

FIGS. 4B-4D each show an example management interface that may be included in the user interface of FIG. 4A for enabling a user to selectively tune the breadth of a synonymic search query to be constructed;

FIG. 5 shows an example operational flow diagram for a synonymic search application of an embodiment that comprises tuning the breadth of a synonymic search query as desired by a user;

FIG. 6 shows an example operational flow diagram for determining the optimal queries to be included in a constructed synonymic search query in accordance with an embodiment of the present invention;

FIG. 7 shows an example operational flow diagram for performing the constructed synonymic search query and ranking the results obtained from such synonymic search query in accordance with an embodiment of the present invention;

FIG. 8 shows one example system in which a synonymic search application in accordance with embodiments of the present invention is implemented on a client computer in a client-server network;

FIG. 9 shows another example system in which a synonymic search application in accordance with embodiments of the present invention is implemented on a server computer in a client-server network; and

FIG. 10 shows an example computer system on which a synonymic search application of embodiments of the present invention may be implemented.

### DETAILED DESCRIPTION

As described above, much information is digitally stored and may be accessible via a local computer and/or via a client-server network. For example, information providers (e.g., website providers) commonly provide information via client-server networks. However, with such an abundance of digital information available (either locally or via client-server networks), it becomes desirable to provide a user with the ability to find the information that he/she desires from the corpus of stored information. Search engines have been provided in the prior art that enable a user to input a search query thereto and retrieve from the corpus of information (e.g., a local database and/or client-server network) information containing the user-specified search query terms. For example, SQL search queries may be performed to search information from a local database communicatively coupled to a computer. As another example, various search engines, such as those identified above, have been developed to aid a user in searching a corpus of information available via a client-server network, such as the Internet.

Given the flexibility and redundancy built into most human languages, many different words and/or expressions may be used to convey a common idea. For example, a thesaurus compiles many words in the English language and identifies synonyms that may be used in place of each word. This characteristic of human languages often leads to difficulty in finding desired information from a corpus of stored information using traditional searching techniques. For instance, as described in greater detail below, traditional search engines generally search for information containing the particular words or expressions specified by a user's search query. However, a provider of information may use different words or expressions to convey the same information that the user desires. Thus, as described earlier, if the user's search query does not include the same words or expressions as used by the information provider, the search engine will likely fail to retrieve such information responsive to the user's search query. Thus, the searching effectiveness of traditional searching techniques are largely dependent upon the user's ability to craft a search query that includes terms and/or expressions that coincide with terms and/or expressions used by the information providers in providing the desired information. Accordingly, traditional searching techniques often fail to discover information that is desired by the user.

As mentioned above, proposals have been made recently for searching techniques that utilize synonymic searching. For example, U.S. Pat. No. 6,167,370 issued to Tsourikov et al. teaches “a search request and key word generator that identifies key words and key combinations of words, and synonyms thereof, for searching the Web internet, intranet, and local data bases for candidate documents.” See Col. 3, lines 5-9 thereof.

As another example, U.S. Pat. No. 6,070,160 issued to Geary (the “'160 patent”) teaches a search engine that utilizes computer-programmed routines, wherein the “routines may utilize a thesaurus and processes for relaxing search requirements to assure a match.” See Abstract thereof. More specifically, the '160 patent teaches that “[s]earch terms may be adapted by methods such as exchanging them with synonyms, truncation, swapping information between fields searched, searching by key words, use of complex indices to rapidly move between different databases, and to broaden the scope of a search and to find elusive relationships between otherwise unrelated fields in different databases, and to selectively ignore or modify search terms that narrow a search excessively.” See Col. 2, line 63-col. 3, line 3 thereof.

As still another example, U.S. Pat. No. 6,078,914 issued to Redfern (the “'914 patent”) teaches a meta-search system which may use synonym expansion for words of a natural language search query. For instance, the '914 patent teaches that “step 116 can perform a synonym expansion for selected words and/or phrases . . . [f]or example, the word ‘discover’ can be expanded to ‘discover or invent or find’.” See Col. 8, lines 63-65 thereof.

However, we have recognized that a desire exists for a technique for managing such synonymic searching techniques. Of course, users may manually craft their own synonymic queries, but that again places the burden of crafting suitable queries on the users. Thus, a system-generated (or autonomous) synonymic search application that aids a user in constructing a synonymic search query becomes desirable. However, such synonymic search applications are typically not used due at least in part to the lack of management of such search applications.

As one example, we have recognized that a desire exists for a system and method for managing the construction of a suitable search query that may comprise one or more synonyms. For instance, in some cases a user may desire a specific search that does not utilize synonyms for the terms of the search query (e.g., when the user is searching a topic with which the user is very familiar or the user is looking for documentation containing a precise term or phrase). However, in other instances, a user may desire the flexibility of including some degree of synonymic searching, depending on how specific or how general the user desires his/her query to be. Thus, a desire exists for a management tool that enables a user to effectively tune the breadth of the synonymic searching to be employed for a given query. Further, assuming that a user desires to broaden a query term with use of a few synonyms for such term, a determination is often needed as to which of the many possible synonyms are best to use for the term. That is, a particular word may comprise many different synonyms, and it may be desirable to limit the breadth of the user's query to only certain ones of such synonyms, in which case a technique for determining the synonyms to employ is desired.

As still a further example, we have recognized that a desire exists for a system and method for managing the results acquired by a synonymic searching technique. For instance, simply because a synonymic search may identify a greater number of potentially relevant documents from the corpus does not necessarily aid the user in finding the most relevant document. Rather, without a suitable technique for ordering the presentation of the documents to the user, the user may be left to find the proverbial needle in a haystack.

Before describing embodiments of the present invention, several definitions are set out immediately below. The following definitions shall control the interpretation and meaning of the terms as used within the specification and claims herein, unless the specification or claim expressly assigns a differing or more limited meaning to a term in a particular location or for a particular application.

“Input query” (or “original query”) is a query received by the synonymic search application. In certain embodiments described below, the input query may be input to the synonymic search application by a user.

“Synonymic query” is a query that is different in wording but synonymous in meaning with the input query. In various embodiments described below, the synonymic search application determines synonymic query(ies) for the input query.

“Synonymic search query” is a query that is constructed by the synonymic search application and executed to search a corpus of information for desired information. In general, an input query is received by the synonymic search application and such application constructs a synonymic search query that comprises at least one query that encompasses the input query and further comprises at least one synonymic query. The synonymic search query may, in certain implementations, comprise a single query that encompasses the input query and at least one synonymic query (e.g., boolean operands may be included to construct such a query). In certain other implementations, the synonymic search query may comprise a plurality of separate queries (e.g., the input query and at least one synonymic query).

“Synonymic search application” is a computer-executable program that is operable to receive an input query and construct a synonymic search query.

“Management tool” is a tool (e.g., computer-executable software) which, in certain implementations, may be included in the synonymic search application, and is operable to manage some aspect of synonymic searching. In certain embodiments described below, the management tool is operable to manage the construction of a synonymic search query such that the synonymic search query has a desired breadth. In certain embodiments described below, the management tool is operable to manage the results returned for a synonymic search query by, for example, ranking the resulting documents. In certain embodiments described below, a management tool may be implemented to manage both construction of a synonymic search query and handling of the resulting documents returned for an executed synonymic search query.

“Information” is intended to encompass informative content (e.g., articles or other publications), as well as services available in a corpus.

“Document” is used herein to refer to an individual item of information (e.g., an individual article, service, etc.), and therefore, the term “document” is not intended to be limited solely to written articles but may encompass any item of information included within a corpus.

Embodiments of the present invention provide tools for managing a synonymic search application. Certain embodiments of the present invention provide tools for managing the construction of a synonymic search query to be employed for a given search for desired information. For example, certain embodiments of the present invention provide a management tool that enables a user to selectively tune the breadth of a synonymic search query to be employed in querying a corpus for desired information. In one embodiment a user interface may be employed that presents a slide bar to a user that enables the user to tune the breadth of the synonymic search query to be employed from “specific” to “general”. Thus, for instance, if a user is very familiar with a topic, he/she may selectively tune the search to be more “specific” in which case fewer (or even no) synonyms may be included in a query of the corpus. On the other hand, if a user is less familiar with a topic, he/she may selectively tune the search to be more “general” in which case a greater number of synonyms may be used in a query of the corpus. As described further below, a constructed “synonymic search query”, as that term is used herein, may comprise a plurality of queries (including an original user-input query).

Further, when only a few of many possible synonyms for a given term are desired to be included in a search, certain embodiments of the present invention provide effective techniques for selecting the synonyms to be used. For instance, in one implementation the user is presented with the possible synonyms and has the option of selecting those synonyms to be included in the constructed synonymic search query. In other implementations, the management tool is operable to autonomously select the synonyms to be utilized. Thus, as described further below, in certain embodiments, a synonymic search application is operable to construct a synonymic search query that comprises a user-input query and the optimal “Q” number of synonymic queries (i.e., queries that are synonymic to the user-input query). In certain embodiments, the number “Q” of queries included in a constructed synonymic search query may depend, at least in part, on the tuned breadth of the constructed synonymic search query.

Certain embodiments of the present invention provide tools for managing the results acquired by a constructed synonymic search query. For instance, as described above, the organization of the acquired results may significantly impact the usefulness of the search results to the user. For example, suppose a constructed synonymic search query is utilized, which results in 250,000 documents being identified by the searching application as satisfying the query. If the user is left to sort through the 250,000 documents to determine those that are most relevant to the topic of interest to the user, the search result has provided relatively little aid to the user. That is, while the search result has narrowed the corpus of documents that may be of interest to the user to 250,000 possible documents, it may be a nearly impossible task for the user to evaluate all 250,000 documents to identify those that most likely address the specific topic of interest to the user.

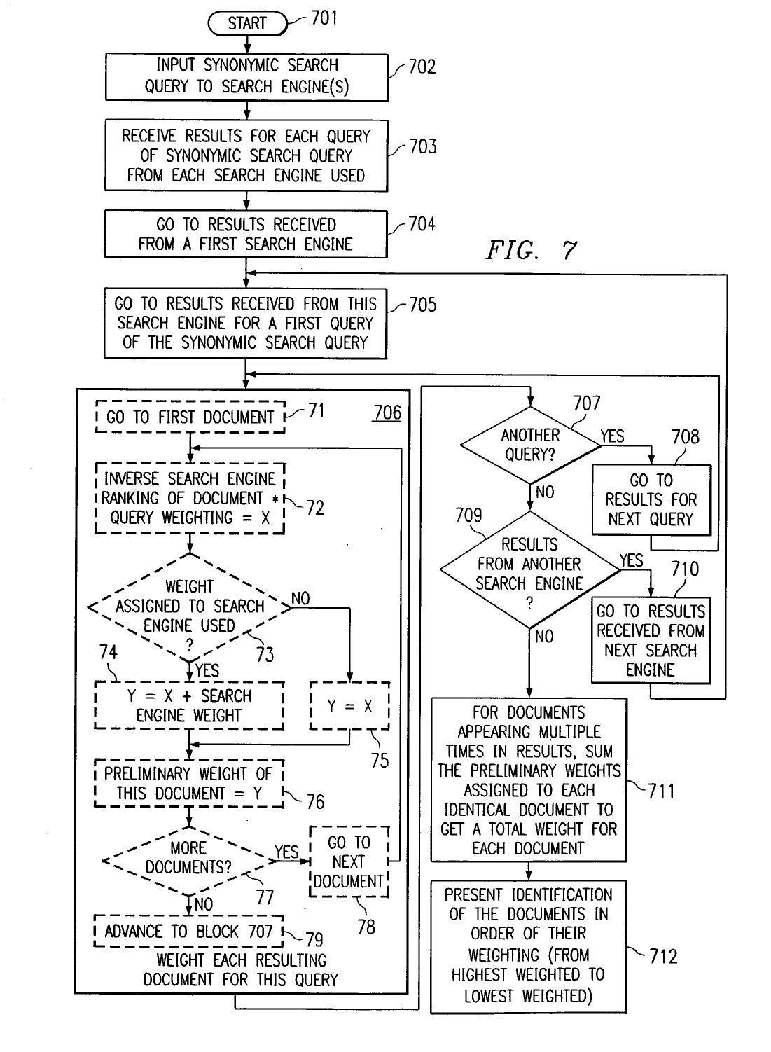

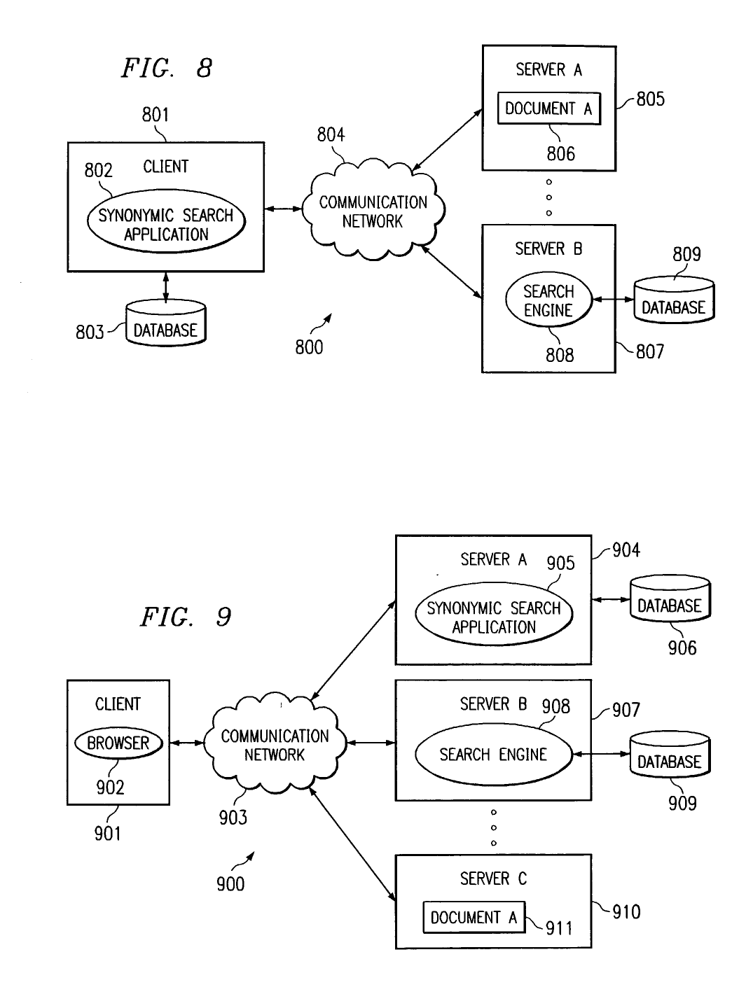

Preferably, the documents included in the acquired results are ranked in some manner. As described above, search engines commonly rank documents acquired for a query. Certain embodiments of the present invention use a novel technique for determining the proper ranking of documents identified by the results of a synonymic search query. For instance, the synonymic search application may implement a technique for weighting the resulting documents that takes into consideration the ranking of the documents by the search engine(s) used for performing the synonymic search query, a weighting assigned to the query of the synonymic search query that resulted in the document being found, and/or a weighting assigned to the search engine that found the document. Various techniques for ranking the resulting documents are described further below in conjunction with FIG. 7.

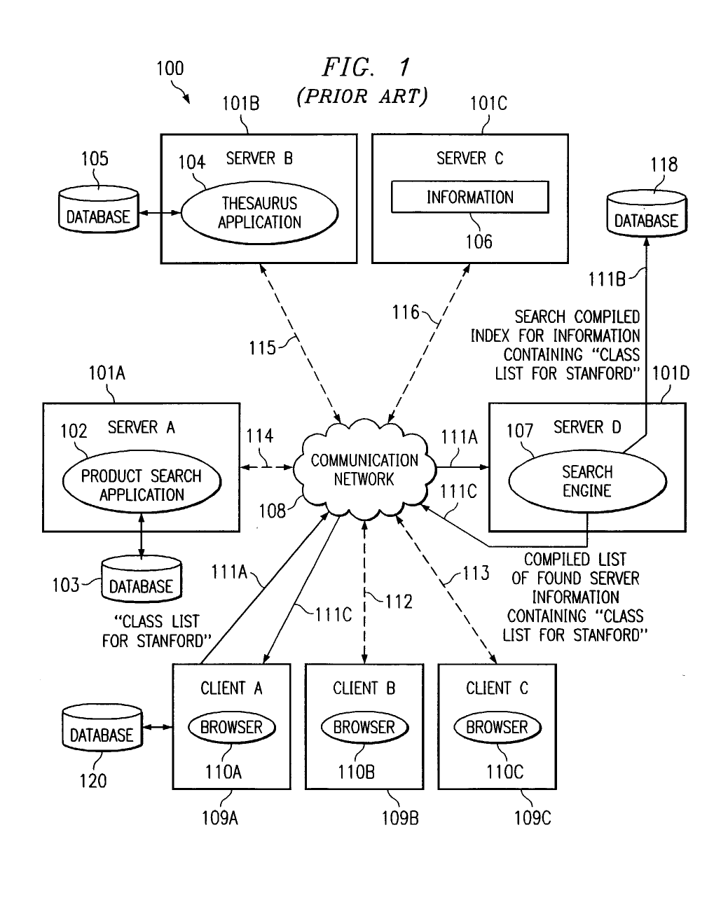

Turning first to FIG. 1, an example client-server system 100 is shown in which embodiments of the present invention may be implemented. As shown, one or more servers 101A-101D may provide information (e.g., services, informative content, etc.) to one or more clients, such as clients A-C (labeled 109A-109C, respectively), via communication network 108. Communication network 108 is preferably a packet-switched network, and in various implementations may comprise, as examples, the Internet or other Wide Area Network (WAN), an Intranet, Local Area Network (LAN), wireless network, Public (or private) Switched Telephony Network (PSTN), a combination of the above, or any other communications network now known or later developed within the networking arts that permits two or more computing devices to communicate with each other.

In a preferred embodiment, servers 101A-101D comprise web servers that may be utilized to serve up web pages to clients A-C via communication network 108 in a manner as is well known in the art. Accordingly, system 100 of FIG. 1 illustrates an example of web servers 101A-101D. Of course, embodiments of the present invention are not limited in application to searching for desired information within a web environment, but may instead be implemented for searching for desired information in various other types of client-server environments. Further, embodiments of the present invention are not limited in application to searching within client-server environments, but may, for example, be implemented within a stand-alone computer for searching a locally-stored corpus of information (e.g., information stored to a local data storage device, such as the computer's hard drive, external data storage device, etc.) that is communicatively accessible by such stand-alone computer. For example, client A (109A) in the example of FIG. 1 is communicatively coupled to a local database 120, and various embodiments of the present invention may be implemented to enable such client computer 109A to search a corpus of information available via database 120. It should be understood that such database 120 may comprise a plurality of databases that store a corpus of information, and in certain embodiments, such database 120 may comprise locally-stored information, remotely-stored information, or both. However, considering the seemingly infinite amount of information that may be available via a client-server network, such as the Internet, a preferred embodiment of the present invention has particular applicability for searching such a client-server network, and therefore example implementations of a preferred embodiment are described hereafter in conjunction with searching the web. Of course, those of skill in the art should appreciate that embodiments of the present invention may be likewise applied to searching of a corpus of information that is not stored in a client-server network, such as information that is stored local to a stand-alone computer (e.g., information in database 120 accessible by computer 109A), and any such implementation is intended to be within the scope of the present invention.

The example client-server network 100 of FIG. 1 illustrates a well-known configuration, wherein each of servers 101A-101D may be selectively accessed by any of clients A-C via communication network 108. Each server 101A-101D may, in certain implementations, comprise a web page that is served up to a client when the client accesses such server. Techniques for serving up web pages to requesting clients are well known in the art, and therefore are not described in greater detail herein. In general, a browser, such as browsers 110A-110C, may be executing at a client computer, such as clients A-C. Examples of well-known browsers that are commonly utilized to enable a user to input a request to access a particular website and to output information (e.g., web pages) received from an accessed website include NETSCAPE NAVIGATOR and MICROSOFT INTERNET EXPLORER. To access a desired web page, a user interacts with the browser to direct the browser to such web page (e.g., by inputting a Universal Resource Locator (URL) corresponding to such web page, clicking on a hyperlink to such web page, etc.), and in response, the browser issues a series of HTTP requests for all objects of the desired web page.

In the example of FIG. 1, server 101C provides information 106 (e.g., services and/or content) that is accessible to clients via communication network 108. Information 106 may comprise a web page in certain implementations. As an example, client 109B may interact with server 101C via communication paths 112 and 116 to access information 106.

Certain servers may be implemented such that they are communicatively coupled to a database, and such servers may be capable of retrieving information from their databases for a client. In the example of FIG. 1, server 101A provides a website that comprises a product search application 102 that enables a user accessing such website to search for products in database 103. For example, the website provider may be a company that manufactures several different products for consumers, and users may, by accessing the provider's website, search information about the company's products available in database 103. Client 109C may interact with server 101A via communication paths 113 and 114 to specify a particular product to search application 102. Search application 102 may then query database 103 for information about the specified product and return any information found to the requesting client 109C.

As another example, server 101B provides a website that comprises an electronic thesaurus application 104 that enables a user accessing such website to search database 105 for synonyms for a specified word. Examples of such an electronic thesaurus website that enables users to input a particular word and search for synonyms for the particular word include the electronic thesaurus website available at http://www.thesaurus.com and the electronic thesaurus website available at http://humanities.uchicago.edu/forms_unrest/ROGET.html. As an example, client 109C may interact with server 101B via communication paths 113 and 115 to input a particular word to electronic thesaurus application 104 and receive from server 101B synonyms found in database 105 for such word.

Some servers, such as server 101D in the example of FIG. 1, provide search engines that enable a user to search for desired information available in the corpus of information provided by the client-server network (e.g., the corpus of information stored to the various servers of the client-server network). Many popular Internet search engines exist, including GOOGLE, LYCOS, YAHOO!, EXCITE, and ALTAVISTA. As shown in the example of FIG. 1, a user may access search engine 107 executing on server 101D and input a search query thereto. For instance, FIG. 1 illustrates an example in which a user of client 109A inputs a search query for “Class List for Stanford”, which is communicated from browser 110A via communication paths 111A to search engine 107. As is well known in the art, search engine 107 may execute to compile a list of “documents” available in the corpus of the client-server network 100 that include “Class List for Stanford” and present that list of documents to the requesting client.

Generally, the search engine maintains in a database 118 an “index” of documents available via the client-server network. Accordingly, responsive to the received search query from client 109A, search engine 107 performs a search 111B of its database 118 for those indexed documents containing “Class List for Stanford”. Thereafter, the compiled list of documents is provided by the search engine 107 to client 109A via communication paths 111C. Typically, each document identified in the list is presented by browser 110A as a hyperlink to the document such that the user may selectively click on any of the identified documents to retrieve them.

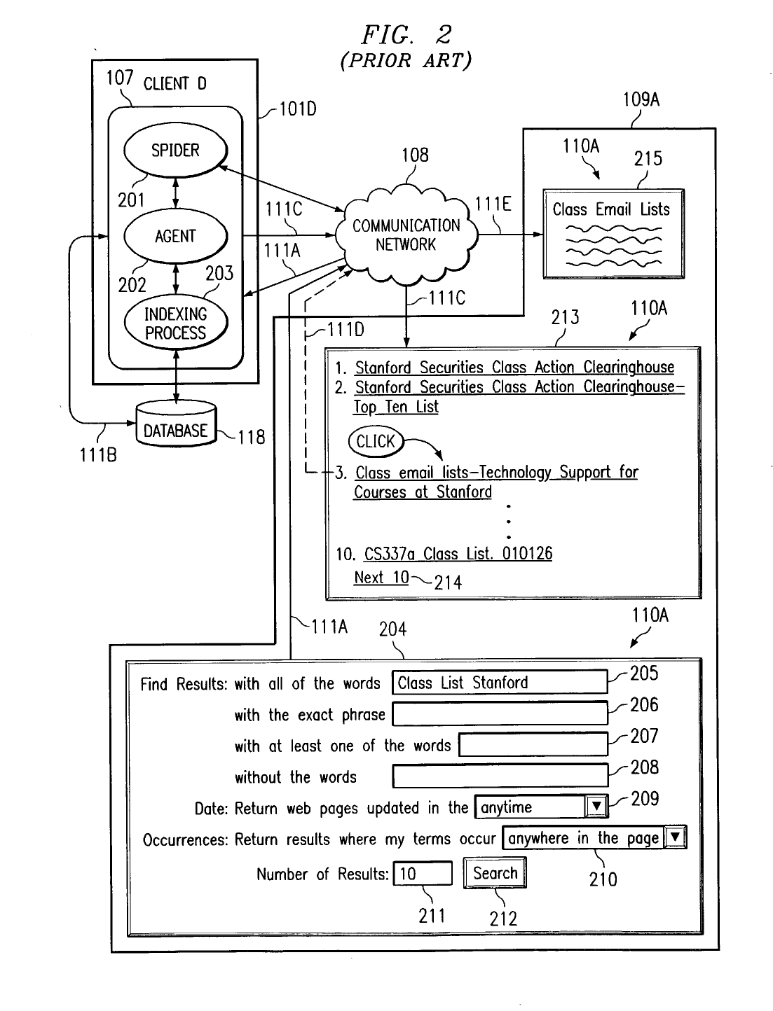

Traditional web search engines are described in greater detail hereafter in conjunction with FIG. 2. Although the specifics of how various search engines operate differ somewhat, generally they are all composed of three parts: at least one “spider,” which crawls across the Internet (or other client-server network) gathering information; a database, which contains all the information the spiders gather; and a search application, which people use to search through the database. As shown in the example of FIG. 2, a traditional search engine 107 typically uses a “crawler” or “spider” application 201 with its own set of rules guiding how documents are gathered from the client-server network 108. Some follow every link on every home page that they find and then, in turn, examine every link on each of those new home pages, and so on. Some spiders ignore links that lead to graphics files, sound files, and animation files. Some ignore links to certain Internet resources such as Wide Area Information Server (WAIS) databases, and some are instructed to look primarily for the most popular home pages.

As the spider application 201 discovers documents and URLs on the client-server network 108, software agent(s) 202 are instructed to get the URLs and documents and send information about them to indexing software 203. Indexing software 203 receives the documents and URLs from the agents 202, and extracts information from the documents and indexes it by putting the information into a database 118. Each search engine extracts and indexes different kinds of information. Some index every word in each document, for example, while others index only the key 100 words in each document. The kind of index built generally determines what kind of searching can be done with the search engine and how the information is displayed. Many other types of spiders or agents exist, including directed agents that are largely indistinguishable from queries.

When a user of client computer 109A directs browser 110A to visit search engine 107 to search the client-server network 108 (e.g., the Internet) for desired information, search engine 107 typically presents a user interface on browser 110A, such as interface 204, to enable the user to input a search query (e.g., a natural language query or boolean query that describes the information the user desires to find). Depending on the search engine, more than just keywords can be used. For example, a user can search by date and other criteria with some search engines.

In the example shown in FIG. 2, interface 204 enables a user to search for documents that include all of the specified words input to input box 205, documents that include the exact phrase input to input box 206, documents that include at least one of the words input to input box 207, and/or documents that do not include the words input to input box 208. Further, the search interface 204 enables a user to specify, in input box 209, a date range in which the documents to be retrieved have been updated (in this example the search is to retrieve documents that have been last updated at anytime). Additionally, the search interface 204 enables a user to specify, in input box 210, where in the documents the specified search terms are to occur in order to satisfy the search query. For instance, the user may specify that the search terms must appear in a common paragraph or in a common sentence of a document in order to satisfy the search query (in this example the search is to retrieve documents that have the specified search terms appearing anywhere in the document). Search interface 204 also allows the user to specify, in input box 211, the maximum number of resulting documents that are to be presented to the user on a given page. In this example, the user specifies that 10 documents are the maximum number to be presented on an output page listing the found documents. User interface 204 further provides search button 212, which when activated causes the constructed query to be performed.

In the example of FIG. 2, the user enters the search query “Class List Stanford” in input box 205, and activates search button 212 to cause the specified query to be performed. In response, the query is communicated via communication paths 111A to search engine 107, which in turn searches its database 118 (via database access 111B) to determine the documents indexed in such database 118 that satisfy the specified query. Thereafter, the resulting documents that satisfy the query are returned via communication paths 111C to browser 110A, and the compiled list of found documents is presented to the user by browser 110A as output 213. That is, the resulting documents, up to the maximum number specified by the user in input box 211 (e.g., 10 in this example), are presented to the user in output screen 213. As described briefly above, most search engines weight the results in some manner and present the documents in order of their weighting, to try to present the user with the most relevant documents first. Thus, the 10 documents determined by the search engine as most relevant are presented in output screen 213. If the user desires to view the next 10 documents, he/she may activate the “Next 10” link 214 to cause the next 10 documents found by the search engine 107 (in order of relevancy) to be presented by output screen 213.

Generally, the resulting list of found documents are returned from search engine 107 as an HTML page, in which each of the found documents are listed as a hyperlink to the corresponding document. That is, each of the 10 documents listed in output screen 213 are a hyperlink to their corresponding document. Thus, for instance, if the user clicks on the third listed document, as shown in the example of FIG. 2, the browser sends a request 111D to retrieve the corresponding document, which is received via response 111E and presented to the user by browser 110A as output screen 215.

Various different search engines are available for searching a corpus of information (e.g., for searching the Internet), and each search engine may be implemented differently such that they each may return a different list of documents found responsive to a given search. That is, different search engines may be differently indexed such that they return completely different documents for a given search, and/or different search engines may use different weighting schemes such that the documents found by each search engine are differently ranked. To cast the widest possible net when looking for information, a user may desire to perform the search using many different search engines. Accordingly, a type of software called meta-search software has been developed. With this software, a user can construct a search query, and the meta-search software submits the search query to many different search engines simultaneously, compiles the results from the search engines, and then delivers the results to the user's computer.

As an example of the operation of a known meta-search software application, a user may input a search query into a user interface provided by the meta-search software application. The meta-search software may then send out many “agents” simultaneously—depending on the speed of the user's network connection (usually from 4 to 8, but can be as many as 32 different agents). Each agent contacts one or more search engines or indexes, such as YAHOO!, LYCOS, and EXCITE. The agents are intelligent enough to know how each search engine functions. For example, the agents know whether a particular engine allows for Boolean searches. The agents also know the exact syntax that each engine requires. Accordingly, the agents put the search query in the proper syntax required by each specific search engine and submit the search query to the search engine.

The search engines then report the results of their search to the agents, and the agents send the results back to the meta-search software. After an agent sends its report back to the meta-search software, it may access another search engine and submit the search query to that engine in proper syntax, and then again sends the results back to the meta-search software. The meta-search software takes all of the results from the search engines and examines them for duplicate results. If it finds duplicate results, it deletes the duplicates, and it then displays the results of the search to the user.

To further aid a user in effectively searching a corpus of information for desired information, recent proposals have been made to use synonymic searching. For instance, electronic thesaurus applications are known (such as those commonly included in word processor applications), and such electronic thesaurus applications may be utilized to determine synonyms for one or more words used in a user-constructed search query. Accordingly, a synonymic search query may be constructed that searches for not only the user-constructed query terms, but also for synonyms of one or more of such terms.

For instance, a synonymic search application may construct a synonymic search query that includes a user-input search query and also includes one or more other queries in which one or more of the terms of the user-input query are replaced with a synonym, and the constructed synonymic search query may effectively be performed such that each query is logically ORed (i.e., to determine if documents are found that satisfy any one of the queries). For example, suppose a user inputs a search for “Class List Stanford” (as in the above-example of FIG. 2), a synonymic search application may determine one or more synonyms for one or more of the words used in the user's query. For instance, the synonymic search application may determine that “division” is a synonym of “class”, and may therefore construct a synonymic search query of “(Class OR Division) List Stanford”, such that documents satisfying either “Class List Stanford” or “Division List Stanford” are found.

Of course, the synonymic search application may, in certain implementations, construct a synonymic search query that comprises a plurality of queries, as opposed to a single query having various terms logically ORed. For instance, in the above example, the synonymic search application may construct a synonymic search query that comprises a first query of “Class List Stanford” (i.e., the user-input query) and a second query of “Division List Stanford”. In this manner, the two queries may each be independently performed, and their results may be combined in the manner described below to produce an appropriate list of found documents to present to the user.

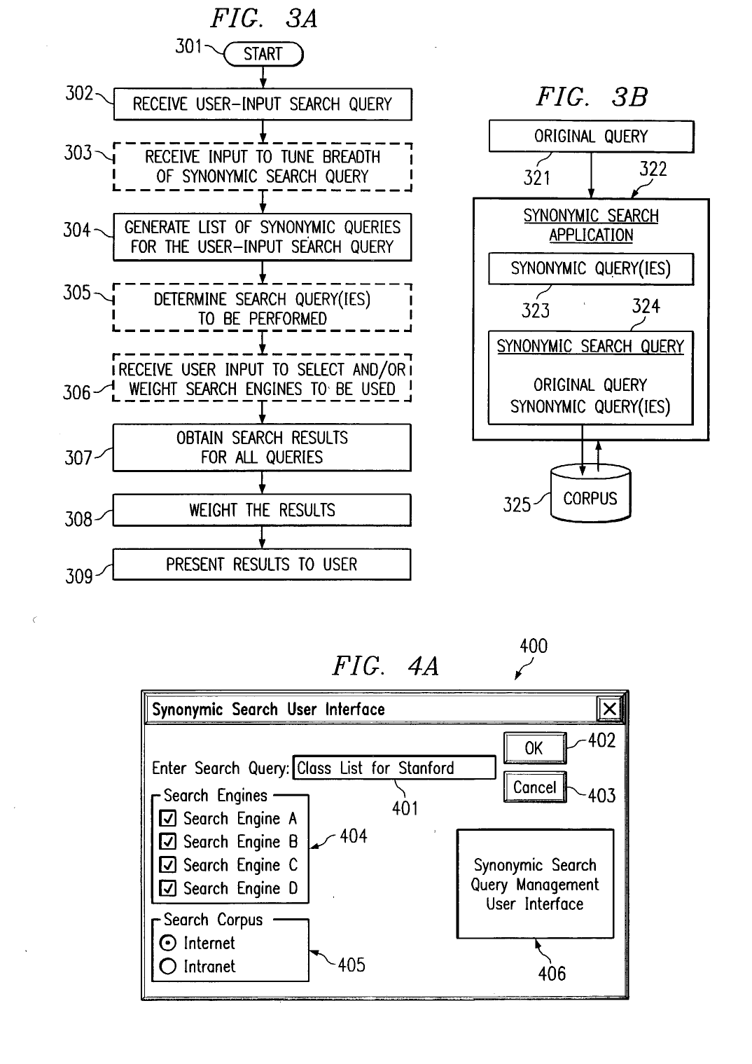

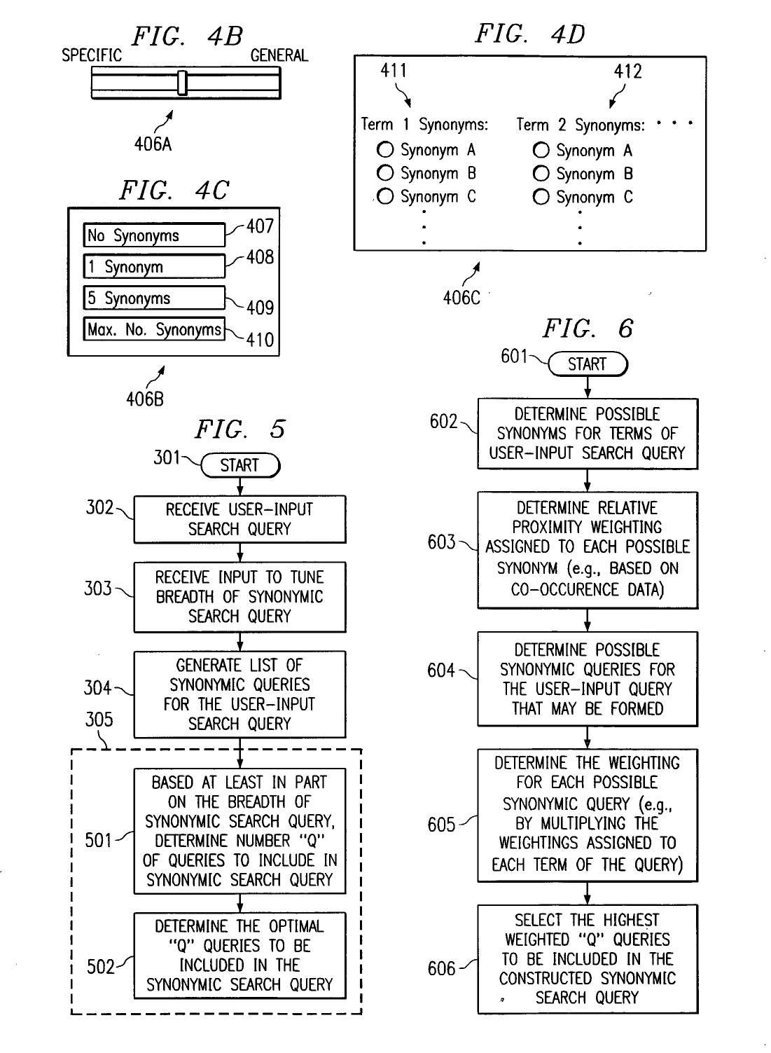

An example operational flow for performing synonymic searching in accordance with one embodiment of the present invention is shown in FIG. 3A. In this example, the operational flow starts in operational block 301. In operational block 302, a user-input search query is received by the synonymic search application. Such synonymic search application may be integrated within a search engine application or it may be implemented as a separate application, as examples. For instance, the synonymic search application may execute in the manner described in conjunction with FIG. 3B below, and it may comprise a user interface, such as that described more fully below with FIGS. 4A-4D for receiving user input. Such user interface may be implemented as an applet or as a selection in a menu (e.g., a pop-up, pull-down, right-click, or other generated menu), as examples.

As described in greater detail hereafter, in certain embodiments of the present invention, the synonymic search application may receive input in block 303 (shown in dashed line as being optional) for tuning the breadth of a synonymic search query to be constructed. For example, the synonymic search application may receive input that specifies whether a specific search is desired (in which case no or very few synonyms may be used in the construction of the synonymic search query) or whether a more general search is desired (in which case a greater number of synonyms for the user-input query terms may be used in constructing the synonymic search query). Thus, a user may, in block 303, specify the breadth of the synonymic search query to be constructed for the user-input query (e.g., the number of synonymic terms to be used in broadening the user-input query).

In operational block 304, a list of synonymic queries for the user-input query is generated. That is, synonyms for one or more of the terms of the user-input query are determined by the synonymic search application. Many commercially-available and freely-available synonym lists (e.g., electronic thesaurus) exist. For example, Cogilex Research and Development Inc. (http://www.cogilex.com) has developed one such electronic synonym list. WordNet (http://www.cogsci.princeton.edu/˜wn/) provides the means to generate another such list, and of course familiar thesaurus options within many word processor engines provide the means to augment the list (or generate independent synonym lists). Accordingly, the synonymic search application may use any such electronic thesaurus now known or later developed to autonomously determine the list of synonyms for words of the received user-input query.

Nouns, verbs, and adjectives are the common parts of speech used for synonymic queries, and depending on whether a term is used as a noun, verb, or adjective, different synonyms may be used for the term. In fact, many common articles (e.g., “the”, “a”, and “an”), prepositions (e.g., “of”, “with”, etc.), and conjunctions (e.g., “but”, “and”, and “or”, except when the latter two are used in Boolean searching) are ignored altogether in most search engines. Accordingly, in certain embodiments, the synonymic search application may analyze the user-input query to determine the corresponding part of speech for each term of such query to select the appropriate synonyms for the terms.

For example, a statistical approach may be implemented for determining the parts of speech (POS) at the front-end of query analysis. For instance, the word “class” may be a noun, verb, or adjective. Using the statistical results from http://www.comp.lancs.ac.uk/ucrel/bncfreq/, for example, the word “class” is found to be most commonly written as a noun, and so the appropriate noun synonyms may be used by the synonymic search application. If, however, a POS analysis (either based on word frequencies or on more sophisticated methods, such as commercial-grade POS engines like that of Cogilex) of the query indicates that the word “class” is a verb, verb synonyms may be found for “class”. This is also true of the word “list”, which can be both a noun and verb. Since even the best POS engines make mistakes, in certain implementations of the present invention, the user may be allowed to change the POS if the user thinks that the engine may have misinterpreted the query. For example, a user interface may be provided by the synonymic search application that enables the user to change or designate the POS for a given query term. Of course, as improved semantic analysis techniques are developed, such techniques may be implemented for improving the synonymic search application (e.g., by better determining the appropriate synonymic terms to use for a given word).

Preferably, the synonymic search set generated by the synonymic search application for a given user-input search query is limited to proximate (and not associated) synonyms in order to keep the number of search queries manageable. “Proximate” synonyms refer to those synonyms that are interchangeable with a given word without altering its meaning, whereas associated synonyms include related words that have similar (although not the same) meaning as a given word. Of course, in certain implementations (and depending on the tuned breadth of the synonymic search query), associated synonyms may also be included in those used by the synonymic search application.

Moreover, many existing search engines separate phrases (idioms) consisting of two words into two separate terms, such as in the case of “take off” and “put up” (in which they are treated as “take” and “off” and “put” and “up”, respectively). In the synonymic search application of embodiments of the present invention, expressions such as “take off” and “put up” are preferably identified and treated by the synonymic search application as single candidates for synonyms, resulting in synonyms such as “launch” for “take off” and “elevate”, “erect”, and “construct” for “put up”, rather than synonyms for the individual words in these idioms.

Further control over the total number of search queries generated by the synonymic search application may be obtained by limiting the number of proximate synonyms, denoted P, to an absolute maximum of, for example, five synonyms (i.e., P=5). If there are N terms for which synonyms are found in the original query, there are N^{P} total search queries possible. However, to prevent an open-ended number of queries, the total number of queries may be limited to an absolute maximum Q of, for example, 25 queries (most search engines are currently fast enough, at several hundredths of a second per query, that this value will typically limit the total search time to <1 second of searching, although connection times may vary).

Additionally or alternatively, the user may be allowed to limit the total number of search queries via a user interface such as a slider tool, a text box, etc. For instance, in certain embodiments, the user's input in operational block 303 of FIG. 3 may specify the breadth of the synonymic searching to be performed, which may in turn dictate the number of synonymic queries to utilize in constructing the synonymic search query to be performed. For instance, if a user is very familiar with a particular topic, then he may desire to perform a specific search in which few (or no) synonymic queries are included; whereas if the user is unfamiliar with a topic, then he may desire to perform a more general search in which more synonymic queries are included in the search (because the user may be unfamiliar with the specific terminology that is commonly used in documents relating to the topic).

Of course, if the synonymic queries used in constructing the synonymic search query are limited in number, then a technique is desired for selecting the optimal synonymic queries (e.g., the best synonyms for a particular term) to use For example, if 5 potential synonyms exist for a term of the user-input query, and only 3 synonymic queries are desired to be used for constructing the synonymic search query, a technique for determining the optimal 3 synonymic queries to use is desired. Accordingly, in certain embodiments of the present invention, the optimal synonymic queries to use may be determined in block 305 (shown in dashed line as being optional) of FIG. 3. For example, in certain implementations, the possible synonyms may be presented to the user and the user may select those to be used in constructing the synonymic search query. For instance, when the user sees certain synonyms it may aid the user in constructing a desired query (e.g., certain terms may jog the user's memory as to how best to search the topic of interest). Additionally or alternatively, the synonymic search application may be operable to autonomously weight the synonymic queries in the manner described more filly below in conjunction with FIG. 6 such that the optimal synonymic queries are more heavily weighted.

Thereafter, in certain implementations, user input may be received in operational block 306 to select and/or weight the search engines to be used in performing the query(ies) determined in block 305. For example, a plurality of different search engines may be used for each, simultaneously performing the optimal search query(ies) determined in block 305. For instance, in a preferred embodiment, publicly-available search engines, such as GOOGLE, YAHOO!, LYCOS, etc. may be used in performing the determined optimal search query(ies) (i.e., for performing a constructed synonymic search query). Further, in a preferred implementation a user may select any one or more of such plurality of search engines to be used in performing the determined optimal search query(ies). The selected search engines may each perform the determined optimal search query(ies) simultaneously much like in the above-described meta-searching techniques.

In operational block 307, the results for the optimal search query(ies) are obtained from the one or more search engines used for performing the searches. It should be understood that potentially an enormous number of documents may be returned for the query(ies) by the various search engines used. Further, some documents may be included in a plurality of the different search results returned. To better aid the user in identifying the likely best documents to review, the synonymic search application preferably weights the obtained results in operational block 308. That is, the synonymic search application preferably uses a weighting scheme to rank the documents in order of most likely relevant to the user's query to least likely relevant to the user's query. It should be understood that the ranking performed by the synonymic search application may combine the results for various different queries performed by various different search engines into a weighted list of documents. Further, it should be recognized that the documents being ranked by the synonymic search application may have already been ranked by the individual search engines used in performing the query(ies). Techniques for weighting the resulting documents that may be implemented by embodiments of the synonymic search application are described in greater detail below in conjunction with FIG. 7 below. Thereafter, a list of the resulting documents identified in order of the weighting of block 308 is presented to the user in operational block 309.

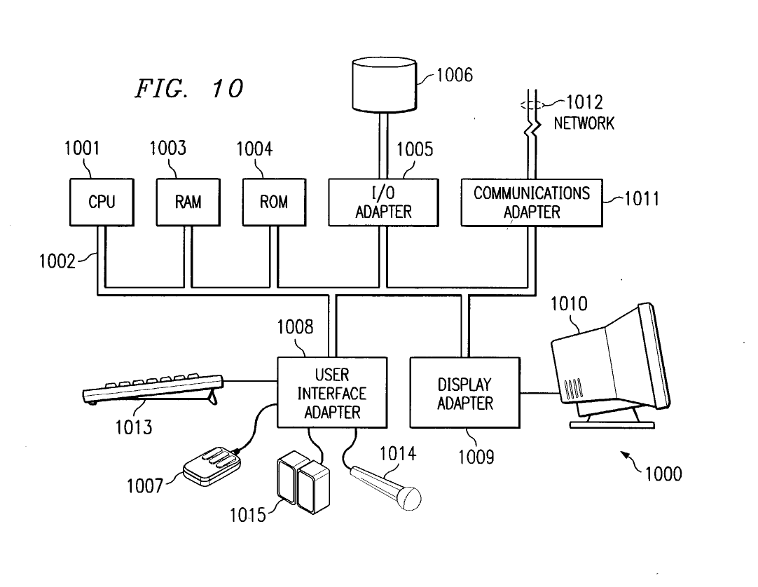

Turning to FIG. 3B, it shows an example block diagram for the functionality of a synonymic search application. As shown, an original query (or “input query”) 321 may be input to a synonymic search application 322, which may be executing on a computer, such as is described hereafter in conjunction with FIGS. 8 and 9. For example, original query 321 is received as in operational block 302 described above in conjunction with FIG. 3A. Synonymic search application 322 is preferably operable to determine synonymic query(ies) 323 that are synonymous in meaning to the received original query 321, as in operational block 304 of FIG. 3A. And, synonymic application 322 is also preferably operable to construct a synonymic search query 324 that is used to search corpus 325 for desired information. As shown, the constructed synonymic search query 324 may comprise original query 321 and at least one synonymic query 323. That is, the constructed synonymic search query 324 comprises at least one query that encompasses original query 321 and further comprises at least one synonymic query 323. The constructed synonymic search query 324 may, in certain implementations, comprise a single query that encompasses original query 321 and at least one synonymic query 323 (e.g., boolean operands may be used to construct such a query). In certain other implementations, the constructed synonymic search query 324 may comprise a plurality of separate queries (e.g., the original query 321 and one or more synonymic queries 323).

Turning to FIG. 4A an example user interface of a preferred embodiment of the present invention is shown. User interface 400 may be provided for a synonymic search application, such as synonymic search application 322 of FIG. 3B, to enable a user to input a query and tune the breadth of the synonymic search query to be constructed. For instance, a user may input a query to input box 401 much like with traditional search engines. In the example of FIG. 4A, a user has input “class list for Stanford” to input box 401. “OK” button 402 is included that when activated (e.g., by a user clicking on it with a pointer, such as a mouse) triggers the synonymic search query to be constructed and executed. As described further below, a constructed synonymic search query preferably comprises the user-input query (of input box 401), as well as one or more synonymic queries for such user-input query, depending on the desired breadth of the synonymic search query. “Cancel” button 403 is included, which may be activated to cancel the process of constructing a synonymic search query.

Search engine selector 404 may be provided to present a list of a plurality of different search engines to a user. The user may select any one or more of such search engines (e.g., by clicking on the check-box next to the corresponding search engine) that are to be used in performing the constructed synonymic search query. In this example, 4 search engines A-D are shown and the user has selected to use all 4 search engines in performing the constructed synonymic search query. Additionally, search corpus selector 405 may be provided to enable a user to select from a plurality of different corpora, such as either the Internet or an Intranet to be searched. In this example, the user has selected to perform the search on the Internet.

Additionally, in a preferred embodiment of the present invention, a management user interface 406 is included in interface 400 to, for example, enable a user to control the breadth of the synonymic search query to be constructed. For instance, if a user is very familiar with the search topic, then the user may desire a very specific search (e.g., using no or very few synonymic queries in addition to the user-input query). On the other hand, if the user is less familiar with the search topic, then the user may desire a more general search (e.g., using more synonymic queries in addition to the user-input query). Various example management interfaces 406 that may be implemented are shown in FIGS. 4B-4D, which are described more fully below.

FIG. 4B shows an example management interface 406A that comprises a slide bar. In this example interface, a user may selectively slide the slide bar's slider from “specific” to “general” to tune the breadth of the synonymic search query to be constructed. For instance, at one extreme, the user may position the slider at “specific” which indicates to the synonymic search that the user is very comfortable with his/her input query and does not desire much aid in broadening it with synonymic queries. For instance, in certain embodiments positioning the slider at “specific” may result in no further synonymic queries being constructed, but instead only the user-input search query (of input box 401) may be performed. The user may progressively broaden the synonymic search query to be constructed by sliding the slider toward “general”. For instance, as the slider moves progressively closer to the “general” side of the slider bar 406A, it may indicate to the synonymic search application that a progressively larger number of synonymic search for the user-input query (of input box 401) is to be included in the constructed synonymic search query. As mentioned above, in certain implementations, the total number of search queries that may be included in the constructed synonymic search query may be capped at some maximum number (e.g., 25 queries). Thus, when the slider is set to “general”, the synonymic search application may construct the most possible search queries (up to the maximum number permitted) to be included in the synonymic search query. In the example interface of FIG. 4B, the user may have very little knowledge of the underlying techniques utilized for broadening the user-input query (e.g., the number of synonyms used, etc.), but may tune the breadth of the constructed synonymic search query to be utilized as desired.

FIG. 4C shows an example management interface 406B that comprises 4 input buttons 407, 408, 409, and 410. In this example, the user may select the number of synonyms (or synonymic queries) to be included in the constructed synonymic search query. For instance, the user may activate button 407 to specify that no synonyms (or synonymic search queries) are to be included in constructing the synonymic search query. That is, by selecting button 407 the user is specifying to the synonymic search application that he/she desires to have only the user-input query (of input box 401) performed. Alternatively, if the user desires to broaden the input query slightly, the user may activate button 408, in which case 1 synonym (or synonymic query) is to be included in the constructed synonymic search query. Alternatively, if the user desires to broaden the input further, the user may activate button 409, in which case 5 synonyms (or synonymic queries) are to be included in the constructed synonymic search query. As another option, if the user desires to broaden the input even further, the user may activate button 410, in which case the maximum number of synonyms (or synonymic queries) are to be included in the constructed synonymic search query. Of course, in an alternative implementation, interface 406B may comprise an input box that enables a user to input a numeric value to specify the number of synonyms (or synonymic queries) to be included in the constructed synonymic search query. It should be recognized that the user may have greater control over the specific construction of the synonymic search query by utilizing interface 406B rather than interface 406A. That is, the user may, in interface 406B specify the exact number of synonyms (or synonymic queries) to be included in the constructed synonymic search query.

FIG. 4D shows an example management interface 406C that outputs lists of synonyms for the terms of the user-input query (of input box 401) from which the user may select the synonyms to be included in constructing the synonymic search query. For instance, in this example, a list 411 of synonyms for a first term of the user-input query (e.g., “class”) is presented with a select box next to each synonym, and a list 412 of synonyms for a second term of the user-input query (e.g., “list”) is presented with a select box next to each synonym. It should be recognized that the example interface 406C provides the user with even greater control over the specific construction of the synonymic search query in that the user may specify not only the exact number of synonyms (or synonymic queries) to be included in the constructed synonymic search query but also the specific synonyms to be used in such queries.

As described above, in a preferred embodiment a synonymic search application is provided that includes a user interface that enables a user to selectively tune the breadth of the synonymic search query to be constructed for a given user-input query. FIG. 5 shows an example operational flow diagram for a synonymic search application of a preferred embodiment in tuning the breadth of a synonymic search query as desired by a user. As with the operational flow of FIG. 3A, operation begins in block 301. Thereafter, a user-input query is received in block 302. For example, a user-input query of “class list for Stanford” is received in input box 401 of FIG. 4A.

In operational block 303, input is received to tune the breadth of the synonymic search query to be constructed. For instance, a user interface tool, such as those of FIGS. 4B-4D, may be provided by the synonymic search application to enable a user to tune the desired breadth of the synonymic search query to be constructed. In operational block 304, the synonymic search application generates a list of synonymic queries for the user-input query. For example, the synonymic search application may determine various synonyms for each term of the user-input query (although, as described above the synonymic search application may not determine synonyms for certain terms included in the user-input query, such as conjunctions, proper names, etc., and the synonymic search application may identify certain idioms and determine synonyms for the idiom rather than the individual words forming the idiom). The synonymic search application may then determine the various synonymic queries (queries that are synonymic to the user-input query) that are possible to construct through different combinations of the synonyms and user-input terms. For instance, suppose the user-input query is “class list for Stanford” and further suppose that 1 synonym is identified for “class” (i.e., “set”) and 2 synonyms are identified for “list” (i.e., “catalog” and “inventory”) with no synonyms being generated for the words “for” and “Stanford”. In this case, the following 6 synonymic search queries are possible through use of various combinations of the user-input terms and the synonyms:

1) “class list for Stanford” (original user-input query);

2) “set list for Stanford”;

3) “class catalog for Stanford”;

4) “class inventory for Stanford”;

5) “set catalog for Stanford”; and

6) “set inventory for Stanford”.

Thereafter, operation advances to block 305 whereat the search query(ies) to be included in the constructed synonymic search query are determined, as described above with FIG. 3A. For instance, continuing with the above example, it is determined in block 305 which of the above 6 search queries are to be included in the synonymic search query that is constructed by the synonymic search application. As shown in FIG. 5, in a preferred embodiment, the determination of such search query(ies) to be included in the constructed synonymic search query is made through execution of blocks 501 and 502. In block 501, a number “Q” of queries to be included in the synonymic search query is determined based at least in part on the breadth desired for the synonymic search query. For instance, if a user tunes the breadth of the synonymic search query (in block 303) to be very specific, then the number “Q” may be determined to be only 1 (i.e., the original user-input search query) or only a few. Alternatively, if the user tunes the breadth of the synonymic search query to be very general, then the number “Q” may be determined to be much larger (e.g., 25 or more), or the user may tune the breadth to any other amount desired. Thus, the tuning of the breadth of the synonymic search query in block 303 may dictate the total number of queries to be included in the constructed synonymic search query.

Of course, the tunable range of “Q” queries that may be available to a user via, for example, a slide bar may vary as a matter of design choice desired for a specific implementation (e.g., may allow for much treater than 25 queries in certain implementations). Further, the tunable range of “Q” queries that is available to a user may, in certain implementations, vary depending on the original input query. For instance, the terms of an original input query may have relatively few synonyms, in which case a user tuning the synonymic search query to “general” (thus desiring a broadened search) may result in the synonymic search application including relatively few synonymic queries in the constructed synonymic search query as relatively few synonymic queries may be possible to construct for the original input query. For example, a term of an input query may have only one or two proximate synonyms (that are interchangeable in meaning with the input term), which may limit the number of synonymic queries that can be constructed using such proximate synonyms. Thus, the tunable range that is available to a user may, in certain implementations, vary depending on the input query. Also, in certain implementations, tuning by a user may expand the construction of the synonymic search query to include synonymic queries formed using associated synonyms for terms of an input query. For instance, if a user tunes the construction of the synonymic search query to “general” and the input query comprises terms that have relatively few proximate synonyms, such tuning by the user may indicate that associated synonyms are desired to be included as well. Thus, in certain implementations, as the user tunes the desired synonymic search query to more general (rather than specific), at some point the synonymic search application may recognize such tuning as desiring the inclusion of not only proximate synonyms but also associated synonyms for one or more of the terms of the input query.

In operational block 502, the optimal “Q” queries to be included in the synonymic search query are determined by the synonymic search application. For instance, continuing with the above example, suppose that it is determined in block 501 that 3 total searches are to be included in the constructed synonymic search query, in block 502 a determination is made as to which 3 of the above-identified 6 queries are the optimal ones to include in the constructed synonymic search query. A preferred technique for determining the optimal queries to include in the synonymic search query based at least in part on an assigned weighting to each synonymic term is described further below in conjunction with FIG. 6.

FIG. 6 shows an example flow diagram for determining the optimal queries to be included in a constructed synonymic search query in accordance with a preferred embodiment of the present invention. The example flow starts in block 601. In block 602, the possible synonyms for terms of a user-input query are determined. In a preferred embodiment, each synonym is assigned a weight value based on its relative proximity (i.e., closeness in meaning) with the original (or “base”) word (i.e., the actual word included in the user-input query). Accordingly, in block 603, the relative proximity weighting assigned to each possible synonym is determined.

The weighting of synonyms may, in certain embodiments, be performed autonomously by the synonymic search application based at least in part on the co-occurrence of the synonymic terms with the user-input terms (or “base” words) of a query in documents of a corpus to be searched. For instance, in a preferred embodiment, a database may be maintained that includes data about the co-occurrence of synonymic terms in documents of a corpus. For example, if N^{P}>Q, the Q−1 additional searches (in addition to the user-input query which is preferably always used) are preferably determined based on the relative synonymic relationship between each of the terms.

The following example more clearly illustrates this point. Suppose the user inputs the query “class list for Stanford”. For the term “class”, the following synonyms are identified by the synonymic search application: set, group, division, grade, rank, category, and order. Thus, 7 synonyms are identified for the term “class”, resulting in 8 candidate terms (including the word “class” itself) that may be used in searching for “class”. For the term “list”, the following synonyms are identified by the synonymic search application: catalog, inventory, register, record, roll, and directory. Thus, 6 synonyms are identified for the term “list”, resulting in 7 candidate terms (including the word “list” itselt) that may be used in searching for “list”. Already, the number of possible synonymic queries for the user input query of “class list for Stanford” is 56 (that is, 8×7). Fortunately, in this example “Stanford” is a relatively unique term; although, “Stanford University” can be considered a synonym for it, this synonym does not expand the search, and so it may be ignored. However, supposing that no more than 25 queries are allowed (e.g., because of the user-tuned breadth of the synonymic search query to be performed and/or because of the synonymic search application's implemented query limits), the above-identified 56 queries need to be reduced to the 25 optimal queries to be utilized.

One solution for determining the 25 queries to be utilized is simply to accept 5 terms for “class” (e.g., accept “class” plus 4 synonyms) and 5 terms for “list” (e.g., accept “list” plus 4 synonyms). The various combinations of arranging the 5 terms for class with the 5 terms for list provide for 25 different search queries that may be formed (5×5). However, this solution is generally not satisfactory in that it often does not result in the optimal 25 queries to be utilized. That is, selecting an equal number of synonyms for each of the user input terms to generate the desired 25 search queries often fails to provide the 25 optimal queries for searching for the desired information. This is because certain words will have “closer” proximate synonymns than others, e.g., “car” has close proximates “automobile” and “vehicle” while “printer” may not have any close proximates.

In a preferred embodiment of the synonymic search application, the synonym database (i.e., the electronic thesaurus or other source from which synonyms are determined) is structured such that the synonyms are rated for their “closeness in meaning” or “proximity” to the original word. Such rating may be performed by the electronic thesaurus, the synonymic search application, some other application, or oa combination thereof. For example, suppose such statistics are available for “class” and “list”, then the various synonyms for each of the terms may be weighted based on their relative proximity to their respective base word (i.e., “class” or “list”). The following example provided in XML format (as XML is preferably used for enabling interaction between the database and the synonymic search application, although other suitable coding languages may be used in alternative implementations) illustrates this point further:

<OriginalWord proximity =“1.0”>

<Spelling>class</Spelling>
<NumberOfSynonyms>12</NumberOfSynonyms>
<Synonym proximity=“ 0.9”>set</Synonym>
<Synonym proximity=“0.85”>group</Synonym>
<Synonym proximity=“ 0.72”>division</Synonym>
<Synonym proximity=“ 0.65”>grade</Synonym>
<Synonym proximity=“0.51”>rank</Synonym>
<Synonym proximity=“0.42”>category</Synonym>
<Synonym proximity=“0.23”>order</Synonym>
. . .

</OriginalWord>
and
<OriginalWord proximity-=“1.0”>

<Spelling>list</Spelling>
<NumberOfSynonyms>15</NumberOfSynonyms>
<Synonym proximity=“0.95”>catalog</Synonym>
<Synonym proximity=“0.9”>inventory</Synonym>
<Synonym proximity=“ 0.88”>register</Synonym>
<Synonym proximity=“0.85”>record</Synonym>
<Synonym proximity=“0.84”>roll</Synonym>
<Synonym proximity=“0.46”>directory</Synonym>
. . .

</OriginalWord>

In view of the above, the various synonyms for “class” may be weighted according to a determined proximity to the term “class”, and the various synonyms for “list” may be weighted according to a determined proximity to the term “list”. For instance, in the above example, the synonyms for “class” in order of their weighting are: “set” (with a weighting of 0.9), “group” (with a weighting of 0.85), “division” (with a weighting of 0.72), “grade” (with a weighting of 0.65), “rank” (with a weighting of 0.51), “category” (with a weighting of 0.42), and “order” (with a weighting of 0.23). Similarly, in the above example, the synonyms for “list” in order of their weighting are: “catalog” (with a weighting of 0.95), “inventory” (with a weighting of 0.9), “register” (with a weighting of 0.88), “record” (with a weighting of 0.85), “roll” (with a weighting of 0.84), and “directory” (with a weighting of 0.46).

In operational block 604 of FIG. 6, the synonymic search application determines the possible synonymic queries for the user-input query that may be formed using various combinations of the user-input terms and possible synonym terms. Thereafter, in block 605, the synonymic search application determines a weight value associated with each possible synonymic query. Preferably, using the “proximity” attribute for each synonym, the overall relevance of a particular query may be obtained by multiplying together all of the proximity weightings for a given synonymic query. For instance, in the above example, the highest-weighted 25 queries are:

1. class×list×Stanford (the original user-input query)=1.0×1.0×1.0=1.0;

2. class×catalog×Stanford=1.0×0.95×1.0=0.95;

. . .

24. grade×catalog×Stanford=0.65×0.95×1.0=0.6175; and

25. division×record×Stanford=0.72×0.85×1.0=0.612.

It should be recognized that in this example implementation the original user-input terms (or “base” words) are assigned the maximum weight value of “1.0”, whereas synonymic terms are assigned weight values depending on their relative proximity to the original user-input term. Thus, the above 25 queries may form the constructed synonymic search query, wherein each of the 25 queries are simultaneously performed. Of course, if the breadth desired for the synonymic search query is different, then more or less than 25 queries may be included therein.

It should be noted that the “weights” or “proximities” defined above may, in certain implementations, be further weighted/treated by the “semantics” of the query. For example, if a user-input query includes the phrase “ball sport”, then any synonyms of “ball” denoting “dancing” rather than “sports equipment” may be discarded by the synonymic search application. Such semantic weighting is, in general, quite difficult, and so weighted synonyms such as those demonstrated above help to work around this problem. That is, it is typically quite difficult to assess the POS of a term in a query, since there is typically relatively little context and often no full phrases nor sentences included in the query. In certain implementations, assumptions on POS can be gained by looking at a POS breakdown for the term in a large corpus, as discussed below.

The proximity weighting for the synonymic terms may be defined in any of various different ways. As one example, such weighting may be manually defined. As another example, the weighting may be defined autonomously by the synonymic search application. In a preferred embodiment of the present invention, such proximity weighting is defined based on the co-occurrence of such terms in documents (e.g., web pages) of a corpus. For instance, http://www.comp.lancs.ac.uk/ucrel/bncfreq/provides a statistical database generated from the British National Corpus, a 100 million word electronic databank sampled from the whole range of present-day English, spoken & written. Thus, the corpus may be periodically monitored by the synonymic search application to determine the number of documents in such corpus in which a given word and a particular synonym of such word co-occur therein, and may assign a weighting for the particular synonym depending on how frequently it co-occurs with the given word. For instance, the corpus may be periodically analyzed by the synonymic search application to determine the number of documents available therein that have both “class” and “set” co-occurring therein. Similarly, the synonymic search application may analyze the corpus to determine the number of documents available therein that have both “class” and “group” co-occurring therein, and so on. Based on the number of documents found in which “class” and “set” co-occur, “set” may be assigned a proximity weighting as a synonym for the word “class”, and based on the number of documents found in which “class” and “group” co-occur, “group” may be assigned a proximity weighting as a synonym for the word “class”. Assuming that more documents are found in which “set” co-occurs with “class” than documents in which “group” co-occurs with “class”, the term “set” is assigned a higher proximity weighting (as in the above example) than “group”. Of course, while “set” may have a higher proximity weighting than “group” for the word “class”, it may not co-occur as often as “group” with some other word (other than “class”), and therefore, for such other word “group” may have a higher proximity weighting than “set”. Such statistically-based methods are robust inasmuch as they reflect “popularity” of occurrences of terms (which is relevant to search engines in general).

The above proximity weighting scheme may be modified and/or improved in various ways to enable the synonymic search application to more accurately determine the proximity of a synonym to a particular base word. As one example, in determining the weighting of synonyms for a given word (or “base” word, such as “class” in the above example), how the synonyms co-occur in a document with the given word may be taken into consideration. For example, a document in which a synonym co-occurs in the same paragraph as the given word may be more heavily weighted than a document in which the synonym co-occurs with the given word but occurs many paragraphs away from the given word. For instance, it may be determined that the closer that a synonym is in location within a document to the given word (i.e., the closer the relative distance of the co-occurrence of the two words within the document), the more likely it is that the author of the document is using the synonym interchangeably with the given word, as opposed to using the synonym in describing a different idea. Thus, in this weighting scheme, a first synonym that co-occurs with a base word in fewer documents of a corpus than does a second synonym, but which co-occurs in a much closer location to the base word within the documents (e.g., within the same paragraph or same sentence) than does the second synonym, such first synonym may be weighted higher than the second synonym.

In certain implementations, the synonymic search application may autonomously define the weighting based on the order in which the synonyms occur in a linguistic engine, such as that provided by WordNet (or other electronic thesaurus that is utilized), in which case the synonymic search application effectively relies on the ranking of the synonyms in the source synonym list utilized. In this case, such an automated assignment by the synonymic search application may result in the following structure (when utilizing WordNet) for “class” (range of proximities from 0 for non-synonyms to 1.0 for “class” itself, so that the 12 synonyms divide the rest of the range into 13 parts):

<OriginalWord proximity=“1.0”>

<Spelling>class</Spelling>
<NumberOfSynonyms>12</NumberOfSynonyms>
<Synonym proximity=“ 0.923”>set</Synonym>
<Synonym proximity=“ 0.846”>group</Synonym>
<Synonym proximity=“ 0.769”>division</Synonym>
<Synonym proximity=“ 0.692”>grade</Synonym>
<Synonym proximity-=“0.615”>rank</Synonym>
<Synonym proximity=“ 0.538”>category</Synonym>
<Synonym proximity=“0.462”>order</Synonym>
. . .

</OriginalWord>

Once the weighting for each possible synonymic query is determined in block 605 of FIG. 6 (e.g., by multiplying the assigned weight value for each word of the query), the highest weighted “Q” queries to be included in the constructed synonymic search query are determined in block 606. For instance, in the above example, the highest weighted 25 synonymic queries (which includes the original user-input query itself) are determined for inclusion in the constructed synonymic search query.

Once the synonymic search query is constructed by the synonymic search application, the query(ies) of such synonymic search query (e.g., the 25 queries in the above example) are performed by one or more search engines. In a preferred embodiment, the query(ies) that form the synonymic search query may be performed in parallel by a plurality of different search engines. For example, some of the queries (e.g., four) may be performed in parallel on a number of different search engines (e.g., four) followed by more (e.g., the next four) queries being performed on the search engines. For instance, the query(ies) of the constructed synonymic search query may be input to well-known search engines, such as that provided by GOOGLE, YAHOO!, LYCOS, etc., and/or any other suitable search engine now known or later developed for a corpus of information. The results are obtained from the search engine(s) by the synonymic search application for the query(ies) of the synonymic search query. Preferably, the synonymic search application then ranks the received results.

FIG. 7 shows a flow diagram for an example operational flow for performing the constructed synonymic search query and ranking the results obtained for such synonymic search query in accordance with a preferred embodiment of the present invention. As shown, operation starts in block 701. Thereafter, in operational block 702, the constructed synonymic search query is input to one or more search engines. As described above, in a preferred embodiment a user is allowed to select one or more of a plurality of different search engines to utilize in performing the constructed synonymic search query. In operational block 703, the synonymic search application receives the results for each query of the synonymic search query from each search engine used. That is, identification of the documents that are found by each search engine for each query of the synonymic search query is received by the synonymic search application.

In operational block 704, the synonymic search application directs its attention to the results received from a first search engine used. In operational block 705, the synonymic search application directs its attention to the results received from this first search engine for a first query of the synonymic search query. Thereafter, these resulting documents are weighted by the synonymic search application in block 706. An example technique for weighting the documents is shown in blocks 71-79 (which are shown in dashed line as being optional). In this example technique for weighting the documents, the synonymic search application directs its attention to a first one of the documents (block 71). It should be recognized that the search engine(s) used for performing the synonymic search query typically present results in some order based on a ranking technique implemented by the search engine. That is, search engines typically utilize some technique for ranking the documents by decreasing relevancy as determined by the search engine (i.e., the most relevant document is presented first followed by the next most relevant document and so on). A preferred embodiment of the synonymic search application takes the ranking of the search engine utilized into account in determining a ranking of the documents.

For instance, in the example weighting technique shown in FIG. 7, the inverse of the search engine ranking is used in assigning a weight to the documents. For instance, suppose that the search engine returns 10 documents ranked 1-10, the first document may receive an inverse weighting of 1/1 (or 1.0), the second document may receive an inverse weighting of 1/2 (or 0.5), and so on, wherein each document receives an inverse weighting of 1 divided by the search engine's ranking of the document. As another example of an inverse weighting scheme, again suppose that the search engine returns 10 documents ranked 1-10, each document may receive an inverse weighting by dividing the total number of documents received by the search engine's ranking of the document. For instance, in this scheme the first document (i.e., the highest ranked document by the search engine) may receive an inverse ranking of 10/1 (or 10), the second document may receive an inverse ranking of 10/2 (or 5), and so on. The inverse weighting scheme is used such that the document ranked highest by the search engine receives the highest weighting, the next highest ranked document receives the next highest weighting, and so on. If the documents were weighted by assigning them each the value of their ranking, then the highest ranked document (the first document) would receive a weighting of 1, while the tenth ranked document would receive a higher weighting of 10. Accordingly, an inverse weighting scheme is preferably used such that the highest ranked document is weighted more heavily than the next highest ranked document and so on. Of course, other techniques may be used in alternative embodiments, including without limitation presenting the documents in reverse order such that the lowest weighted document is shown first and progresses to the highest weighted document presented last.

In operational block 72 of the example of FIG. 7, the inverse search engine ranking of a document is multiplied by a weighting assigned to the query that resulted in the document being returned. It should be recalled from the above description of the construction of the synonymic search query that the queries included in the synonymic search query may be weighted (see e.g., FIG. 6 and the description thereof). For instance, in an example described above, a synonymic search query is constructed for the user-input query of “class list for Stanford” that comprises the following highest weighted 25 search queries:

1. class×list×Stanford (the original user-input query)=1.0×1.0×1.0=1.0;

2. class×catalog×Stanford=1.0×0.95×1.0=0.95;

. . .

24. grade×catalog×Stanford=0.65×0.95×1.0=0.6175; and

25. division×record×Stanford=0.72×0.85×1.0=0.612.

As the above example illustrates, each query included in the synonymic search query has a weight value assigned to it (which may be referred to as its “synonymic proximity weighting”). Other schemes may be used for weighting the queries used in the synonymic search query. For instance, while the above example generates the weighting for the queries a priori (before the synonymic search query is performed), in certain implementations the weighting of the queries may be performed post-hoc (after the synonymic search query is performed). For instance, in one implementation the queries of a synonymic search query may be weighted as follows: a) weighting for original, user-input query=1.0; b) weighting for queries which share keywords (nouns) with original, user-input query=0.5; c) weighting for queries which have synonyms for keywords in original query=0.2; and d) weighting for other queries=0.1. Various other techniques may be used for weighting the queries included in the synonymic search query.

In a preferred embodiment,the weighting of a query included in the synonymic search query is taken into consideration in ranking the results obtained for such query. For instance, in block 72 the inverse search engine ranking of a document is multiplied by the query weighting to obtain a value “X” for the document. For instance, suppose the query “class catalog Stanford” of the above example is performed, which has a query weighting of 0.95. In operational block 72, for a document returned by the search engine, the inverse ranking assigned to such document by the search engine is multiplied by the query weighting of 0.95 to determine the value “X” for such document.

In certain embodiments, search engines may be assigned weighted values. For example, a user may prefer one search engine over another, and may therefore assign a higher weighting to the preferred search engine. That is, the user may trust the search engine www.mygoodsearchengine.com more than the search engine www.mypatheticsearchengine.com and may therefore desire to accordingly weight the results from these search engines. Accordingly, in operational block 73, the synonymic search application may determine whether the search engine from which the results have been received is assigned a weighted value. If the search engine is weighted, then a value “Y” for the document under consideration is determined as the sum of “X” for that document and the search engine weight value in block 74. If, on the other hand, the search engine is not weighted, then the value “Y” is set equal to “X” for the document under consideration in operational block 75. In either case, operation then advances to block 76 whereat the preliminary weight of the document under consideration is determined to be the value “Y”.

In operational block 77, the synonymic search application determines whether more resulting documents are available for the query under consideration. If more resulting documents are available for this query, then the synonymic search application directs its attention to the next identified document in block 78, and execution returns to block 72 to assign a preliminary weight value to this next document. Once it is determined at block 77 that no more resulting documents were returned by the search engine under consideration for the query under consideration, then operation advances to block 707 (as shown in block 79).

While an example technique for weighting the documents returned from a search engine for a query is described above in conjunction with blocks 71-79, it should be understood that various other weighting techniques may be implemented in alternative embodiments of the present invention. For example, novelty of the reported and/or analyzed keywords of the documents returned responsive to the synonymic search query may also be used for weighting. Such keywords can be reported by the document (e.g., website/webpage) itself, or can be analyzed using natural language processing (NLP) methods. This final weighting by novelty can be gained by using document clustering, then selecting the highest-weighted document(s) from each cluster to report.

Once each document of a search query under consideration is assigned a preliminary weighting in operational block 706, operation advances to block 707 whereat the synonymic search application determines whether another query is included in the synonymic search query. If another query is included, then the synonymlic search application directs its attention to the results of the next query of the synonymic search query (received from the search engine under consideration) in block 708, and returns operation to block 706 to assign preliminary weight values to each of the documents identified in such results.

Once it is determined in block 707 that no further queries are included in the synonymic search query, then operation advances to block 709 whereat the synonymic search application determines whether results were received from another search engine. For instance, if the synonymic search query is executed on a plurality of different search engines, then results are received from each of such plurality of different search engines. If it is determined in block 709 that results were received from another search engine, then the synonymic search application directs its attention to the results received from the next search engine in block 710. The synonymic search application then returns its operation to block 705 to evaluate the results received for the query(ies) of the synonymic search query and assign a preliminary weight value to each of the identified documents in the results.

Once it is determined in block 709 that no further results from other search engines have been received (i.e., all received results have been evaluated and assigned a preliminary weight value), then operation advances to block 711. It should be recognized that certain documents may be identified in the results of different queries included in the synonymic search query. For instance, identification of a certain document may be included in those returned by a search engine responsive to the query “class list Stanford”, and identification of the same document may also be included in the returned results from the search engine responsive to the query “class catalog Stanford”. Additionally, if multiple search engines are used, a document may be returned in the results for one or more queries performed by a plurality of the search engines used. Thus, a document may appear multiple times in the resulting lists of documents received from the search engine(s) for the query(ies) of a synonymic search query. As described above, in a preferred embodiment each appearance of the document receives a weighting (which may be different for each appearance depending on such factors as the weighting of the query that resulted in the document being returned, the ranking of the document by the search engine that returned it, and/or the weighting assigned to the search engine that returned the document).

Accordingly, in operational block 711 the documents appearing multiple times in the received results have their respective preliminary weight values summed to calculate a total weight value to be assigned to that document. For those documents appearing only once in the results received, their preliminary weight value determined in block 706 becomes their total weight value. Thereafter, identification of the resulting documents is presented by the synonymic search application to a user with the resulting documents sorted in order of their assigned total weight value (from highest weighted to lowest weighted) at block 712. Of course, in certain implementations only a portion of the total received results may be presented to the user at a time. For instance, the first 10 results (i.e., the highest 10 weighted documents) may be presented to the user, and if the user desires to see more of the results the user may input a request (e.g., by clicking on a “Next 10” button) to view the next 10 results, and so on.

In the above example, the results received for the various queries included in a constructed synonymic search query and/or received from the various search engines used are presented to a user in a combined (ranked) list. That is, rather than presenting the results for each query of a synonymic search query and/or received from each search engine separately, the example implementation of a synonymic search application described above constructs an integrated result list that includes the received results for all queries of the synonymic search query and/or the results received from all search engines used.

In an alternative embodiment, rather than combining the results into an integrated list of documents that is presented to the user, the results may be presented to the user “by query” and/or by search engine. For instance, the results obtained for each of the queries of a synonymic search query may be presented as a hyperlink to the user, and the user can select any of them to find the resulting documents included therein. For example, the user may be presented with the following results:

Click here for results of original query: “class list for Stanford”

Click here for results of synonymic query: “class catalog for Stanford”

. . .

Click here for results of synonymic query: “grade catalog for Stanford”

Click here for results of synonymic query: “division record for Stanford”

Further, the resulting documents for each query may be ranked by the search engine and/or by the synonymic search application. For instance, in one implementation the results for each query received from a plurality of different search engines may be integrated into a list of results for that query, and such documents may be ranked in a manner similar to that described above with FIG. 7. For example, the query “class list for Stanford” may be executed on a plurality of different search engines, and the results obtained from each search engine may be weighted and combined by the synonymic search engine to produce a ranked listing of the documents identified for this query by the plurality of search engines used. Alternatively, the queries may further be separated by search engine. As another example, the synonymic search application may present a tree of the original and synonymic searches such as found at http://www.vivisimo.com.

It should be recognized that the various presentation schemes have different advantages. The first scheme described above (in which results for all queries received from all search engines used are combined into an integrated list of resulting documents) tends to smooth over biases of a search engine, providing averaging of documents (e.g., websites), while the second scheme described above provides quick alternative lists to the user for each query of a synonymic search query. A preferred motif may be to present the results from the first scheme (i.e., the integrated list of resulting documents) to the user and also provide links to each query of the synonymic search query in an adjacent column, such that the user can view the integrated list and also has the option of viewing the results received for each individual query of the synonymic search query.

An additional presentation mode is possible. In this mode, the overall relevance of all the search results is determined by comparing its keywords to those in the original, user-input query. For example, keywords can be self-reported by a website as “metadata” about the page (these are handled, for example, in HTML as meta name=“description” content=“ . . . ” and meta name=“keywords” content=“ . . . ” metatags that are added to the web page for indexing purposes). Such keywords are not relevant to the browser, but are markup tags viewed by web spiders. Keywords can also be derived from the content of the documents (e.g., web pages themselves). In certain embodiments, the top result(s) of each individual query included in a synonymic search query may be presented to a user, which may widen the breadth of the search query—e.g., provides a trade-off between overall weight and weight within a novel query.

For example, again assuming that the above-described synonymic search query constructed for the user-input query of “class list for Stanford” is performed, suppose the following two web page descriptions result:

1) A List of people suing Stanford for copyright infringement . . .

2) A directory of classes in the Stanford biology program . . .

The first search has “list” at 1.0, “Stanford” at 1.0 and no synonym for class. Its total synonymic weight (using the simplest weighting schema) is thus 2.0. The second search has “directory” for 0.46, “class” (lemma for classes) for 1.0, and “Stanford” for 1.0, for a total weighting of 2.46. Thus, the second resulting document is deemed “more semantically similar” to the original query and is presented higher up in the results. This provides yet another way to present the results to a user.

The following details a real example that illustrates the advantages to managing a synonymic search application according to the teachings of the present invention. On one of the major internet search engines, the following query was entered: “ball sport in New Zealand” for which the user was hoping to find the names of a sport in which a person gets inside a large, plastic, double-walled ball and rolls down a hill (called “zorbing”, a New Zealand invention, as it turns out) and the name for a sport similar to basketball played by women there (“netball”, as it turns out). Both are quite literally ball sports in New Zealand, but they are quite different from the set of top ten results that are received for this query in most search engines (almost all are rugby, with basketball or volleyball occasionally making an appearance).

The query was then input to the synonymic search application of an embodiment of the present invention. The chief synonyms identified by the synonymic search application were “sphere”, “globe”, and “orb” for the term “ball”; and “game”, “activity”, “team game”, and “hobby” for the term “sport”. The original search “ball sport New Zealand” found chiefly rugby sites, with some hockey and water sports interspersed in the top 10 priority sites. Similar results were obtained for the query “sphere sport New Zealand”. When the query “globe sport New Zealand” was performed, more water sports sites appeared. When “orb sport New Zealand” was queried, zorbing made its first appearance in the high priority list of sites. Water polo appeared when “ball activity New Zealand” was queried; croquet & volleyball when “ball team game New Zealand” was queried; and netball when “ball game New Zealand” was queried. This example illustrates the diversity of returns possible with the use of synonymic queries. This example emphasizes the breadth possibilities of synonymic searching, and also how if only one or a few of the highest results of each query are presented, the desired documents for “zorbing” and “netball” show up.

Embodiments of the present invention advantageously enable construction of a synonymic search query tuned to a desired breath. By expanding the original, user-input query in a logical, meaningful fashion, at least two advantages may be recognized: (1) related searches may be performed to allow the possibility of finding documents that could not be found directly by the original, user-input query, and (2) statistics about the multiple queries that form a synonymic search query are generated that allow different resulting documents to be ranked in a meaningful manner.

Certain embodiments of the present invention may be implemented to expand the capabilities of existing search engines in many fashions. Also, a weighted synonymic search application of embodiments of the present invention may be implemented for use in web searching, database searching, and for many other text-based data-mining purposes, such as semantic comparisons (how similar are two documents, sentences, etc., semantically), summarization metrics (which are the key sentences in a document, e.g., redundancy of sentences can be estimated by calculating synonymic overlap between sentences, etc.), as well as various other applications.

Embodiments of the present invention may be implemented in many different ways. For instance, FIG. 8 shows one example implementation 800 in which a synonymic search application 802 in accordance with embodiments of the present invention is implemented on a client computer 801. Client computer 801 may be communicatively coupled to a database 803, and synonymic search application 802 may be utilized for searching for desired information in the corpus of information in database 803. Alternatively or additionally, client computer 801 may be communicatively coupled to communication network 804. Communication network may be any suitable communication network, such as described above in FIG. 1 with communication network 108. As further shown, server 805 that comprises document A 806 stored thereto may also be communicatively coupled to communication network 804. And, server 807 comprising search engine 808 (that may be communicatively coupled to database 809 for storing indexed documents as with database 118 described above in FIGS. 1 and 2) may also be communicatively coupled to communication network 804. Thus, synonymic search application 802 may, in certain implementations, be executing on client 801 to search for desired information from the corpus of information available on the client-server network 804. For instance, a synonymic search query may be constructed by synonymic search application 802, and synonymic search application 802 may interact with search engine 808 to obtain identification of documents satisfying the synonymic search query (e.g., document A 806 of server 805), as described above. Synonymic search application 802 may include code for implementing the management schemes described above (e.g., managing the breadth of the synonymic search query to be constructed and/or managing the ranking of resulting documents returned by the synonymic search query).

FIG. 9 shows another example implementation 900 in which a synonymic search application 905 in accordance with embodiments of the present invention is implemented on a server computer 904. As shown, a client computer 901 may have a browser application 902 executing thereon, and such client computer 901 may be communicatively coupled communication network 903 such that a user may access server 904. Communication network 903 may be any suitable communication network, such as described above in FIG. 1 with communication network 108. Thus, a user may from client computer 901 access server 904 and interact with synonymic search application 905 executing on such server 904. Server 904 may be communicatively coupled to a database 906, and synonymic search application 905 may be utilized for searching for desired information in the corpus of information in database 906. Alternatively or additionally, a user may interact with synonymic search application 905 for searching for desired information from the corpus of information available on client-server network 903. For instance, server 907 comprising search engine 908 (that may be communicatively coupled to database 909 for storing indexed documents as with database 118 described above in FIGS. 1 and 2) may also be communicatively coupled to communication network 903. And, server 910 that comprises document A 911 stored thereto may also be communicatively coupled to communication network 903. Thus, synonymic search application 905 may, in certain implementations, be executing on server 904 to search for desired information from the corpus of information available on the client-server network 903. For instance, a synonymic search query may be constructed by synonymic search application 905, and synonymic search application 905 may interact with search engine 908 to obtain identification of documents satisfying the synonymic search query (e.g., document A 911 of server 910), as described above. Again, synonymic search application 905 may include code implementing the management functions described above. It should be recognized that the synonymic search application may be implemented in various other ways, including without limitation being implemented as part of another, application, such as search engine 908. It should be understood that the operational flow diagrams of FIGS. 3A, 5, 6, and 7 are intended only as examples for implementing their respective functionalities, and one of ordinary skill in the art will recognize that in alternative embodiments the order of operation for the various blocks may be varied, certain blocks may be performed in parallel, certain blocks of operation may be omitted completely, and/or additional operational blocks may be added. Thus, the present invention is not intended to be limited only to the operational flow diagrams of FIGS. 3A, 5, 6, and 7 for implementing the functionality achieved by such flow diagrams, but rather such operational flow diagrams are intended solely as examples that render the disclosure enabling for many other operational flow diagrams for implementing such functionality.

When implemented via computer-executable instructions, various elements of the synonymic search application of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

FIG. 10 illustrates an example computer system 1000 adapted according to embodiments of the present invention. That is, computer system 1000 comprises an example system on which the synonymic search application of embodiments of the present invention may be implemented (such as client computer 801 of the example implementation of FIG. 8 and server computer 904 of the example implementation of FIG. 9). Central processing unit (CPU) 1001 is coupled to system bus 1002. CPU 1001 may be any general purpose CPU. The present invention is not restricted by the architecture of CPU 1001 as long as CPU 1001 supports the inventive operations as described herein. CPU 1001 may execute the various logical instructions according to embodiments of the present invention. For example, CPU 1001 may execute machine-level instructions according to the exemplary operational flows described above in conjunction with FIGS. 3A, 5, 6, and 7.

Computer system 1000 also preferably includes random access memory (RAM) 1003, which may be SRAM, DRAM, SDRAM, or the like. Computer system 1000 preferably includes read-only memory (ROM) 1004 which may be PROM, EPROM, EEPROM, or the like. RAM 1003 and ROM 1004 hold user and system data and programs (such as that used by the synonymic search application of embodiments of the present invention), as is well known in the art.

Computer system 1000 also preferably includes input/output (I/O) adapter 1005, communications adapter 1011, user interface adapter 1008, and display adapter 1009. I/O adapter 1005, user interface adapter 1008, and/or communications adapter 1011 may, in certain embodiments, enable a user to interact with computer system 1000 in order to input information, such as a search query and/or information for tuning the breadth of a synonymic search query to be constructed, as examples.

I/O adapter 1005 preferably connects to storage device(s) 1006, such as one or more of hard drive, compact disc (CD) drive, floppy disk drive, tape drive, etc. to computer system 1000. The storage devices may be utilized when RAM 1003 is insufficient for the memory requirements associated with storing data for the synonymic search application. Communications adapter 1011 is preferably adapted to couple computer system 1000 to network 1012 (e.g., communication network 108, 804, 903 described in FIGS. 1, 2, 8, and 9 above). User interface adapter 1008 couples user input devices, such as keyboard 1013, pointing device 1007, and microphone 1014 and/or output devices, such as speaker(s) 1015 to computer system 1000. Display adapter 1009 is driven by CPU 1001 to control the display on display device 1010 to, for example, display the user interface (such as that of FIGS. 4A-4D) of the synonymic search application.

It shall be appreciated that the present invention is not limited to the architecture of system 1000. For example, any suitable processor-based device may be utilized, including without limitation personal computers, laptop computers, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

What is claimed is:

1. A method for computerized searching for desired information from a corpus of information, the method comprising:
receiving a query for desired information; and
receiving input tuning an amount of synonymic broadening to be applied to said received query for constructing a synonymic search query to be utilized for searching for said desired information.

2. The method of claim 1 wherein said constructing a synonymic search query comprises:
constructing at least one synonymic query that comprises a synonymic term in place of at least one term of said received query.

3. The method of claim 1 wherein said constructing a synonymic search query further comprises:
identifying an idiomatic phrase in said received query; and
determining a synonymic term to be used in place of said idiomatic phrase in constructing at least one synonymic query.

4. The method of claim 1 wherein said constructing a synonymic search query comprises constructing at least one synonymic query that comprises a synonymic term in place of at least one term of said received query, wherein said synonymic term is proximate in meaning with said at least one term of said received query.

5. The method of claim 1 wherein said constructing a synonymic search query comprises constructing at least one synonymic query that comprises a synonymic term in place of at least one term of said received query, wherein said synonymic term is an associated synonym to said at least one term of said received query.

6. The method of claim 1 wherein said constructing a synonymic search query comprises:
constructing at least one synonymic query that is synonymous in meaning with said received query.

7. The method of claim 1 further comprising:
responsive to said tuning, determining how many synonyms are to be used for said received query in constructing said synonymic search query; and
for the determined number of synonyms to be used, ascertaining the optimal synonyms to be used in constructing said synonymic search query.

8. The method of claim 1 further comprising:
responsive to said tuning, determining how many synonymic queries that are synonymous in meaning to said received query are to be used in constructing said synonymic search query.

9. The method of claim 8 further comprising:
for the determined number of synonymic queries, ascertaining the optimal synonymic queries to be used in constructing said synonymic search query.

10. The method of claim 8 further comprising:
weighting the synonymic queries based at least in part on determined co-occurrence of synonymic terms of said synonymic queries with terms of said received query in documents of said corpus; and
ascertaining the optimal synonymic queries to be used in constructing said synonymic search query based at least in part on said weighting of said synonymic queries.

11. The method of claim 8 further comprising:
for at least one term of said received query, assigning a weight value to each of a plurality of synonyms for said at least one term based at least in part on each synonym's respective proximity in meaning to said at least one term; and
ascertaining the optimal synonymic queries to be used in constructing said synonymic search query based at least in part on said weighting of said synonyms.

12. The method of claim 8 further comprising:
for at least one term of said received query, identifying at least one synonym;
determining a proximity in meaning of each of said at least one synonym to said at least one term; and
ascertaining the optimal synonymic queries to be used in constructing said synonymic search query based at least in part on said determined proximity of said at least one synonym.

13. The method of claim 8 further comprising:
for at least one term of said received query, identifying at least one synonym;
for each at least one synonym, determining the number of documents in said corpus in which the synonym co-occurs with said at least one term;
based at least in part on the number of documents determined for each of at least one synonym, determining a proximity in meaning of each of at least one synonym to said at least one term; and
ascertaining the optimal synonymic queries to be used in constructing said synonymic search query based at least in part on said determined proximity of said at least one synonym.

14. The method of claim 8 further comprising:
for at least one term of said received query, assigning a weight value to at least one synonym for said at least one term based at least in part on each synonym's respective proximity in meaning to said at least one term;
using the weight values assigned to each term of a synonymic query to compute a weight value for said synonymic query; and
ascertaining the optimal synonymic queries to be used in constructing said synonymic search query based at least in part on said weighting of said synonymic queries.

15. The method of claim 14 further comprising:
multiplying the weight values assigned to each term of a synonymic query to compute said weight value for said synonymic query.

16. The method of claim 1 wherein said constructing a synonymic search query comprises:
constructing at least one query that encompasses said received query and further comprises at least one other query that is synonymous in meaning to said received query.

17. The method of claim 1 wherein said constructing a synonymic search query comprises:
constructing a synonymic search query that comprises a plurality of search queries, wherein said plurality of search queries comprise said received query and at least one other query that includes at least one synonym for at least a portion of said received query.

18. The method of claim 1 wherein said receiving input tuning the amount of synonymic broadening to be applied to said received query comprises:
receiving input specifying how general the constructed synonymic search query is desired to be.

19. The method of claim 18 wherein said constructing a synonymic search query comprises:
determining the number of synonymic queries that are synonymous in meaning with said received query that are to be used for constructing said synonymic search query, wherein the more general the constructed synonymic search is desired to be, the more synonymic queries that are used for constructing said synonymic search query.

20. The method of claim 1 wherein said corpus of information is stored in a client-server network, said method further comprising:
performing said constructed synonymic search query to search for said desired information via said client-server network.

21. Computer-executable software code stored on a computer-readable medium, said computer-executable software code comprising:
code for presenting a user-interface that enables a user to tune an amount of synonymic broadening to be applied to an input query; and
code responsive to received tuning input for generating a synonymic search query having a desired breadth for searching a corpus of information for desired information.

22. The computer-executable software code of claim 21 further comprising code for presenting a user-interface that enables a user to input said input query.

23. The computer-executable software code of claim 21 wherein said synonymic search query comprises at least one synonymic query having a synonymic term in place of at least one term of said input query.

24. The computer-executable software code of claim 23 wherein said at least one synonymic query is interchangeable in meaning with said input search query.

25. The computer-executable software code of claim 21 further comprising:
code for autonomously selecting at least one synonymic term to be used in constructing at least one synonymic query.

26. The computer-executable software code of claim 21 further comprising:
code for identifying an idiomatic phrase in said input query; and
code for determining at least one synonym for said idiomatic phrase.

27. The computer-executable software code of claim 21 wherein said code for generating a synonymic search query further comprises:
code, responsive to said received tuning input, for determining how many synonymic queries to use in said synonymic search query.

28. The computer-executable software code of claim 27 wherein said code for generating a synonymic search query further comprises:
code for determining, for the determined number of synonymic queries, the optimal synonymic queries to be used in said synonymic search query.

29. The computer-executable software code of claim 21 wherein said code for generating a synonymic search query further comprises:
code for weighting synonymic queries based at least in part on determined co-occurrence of synonymic terms of said synonymic queries with terms of said input search query in documents of said corpus of information; and
code for determining, for a determined number of synonymic queries, the optimal synonymic queries to be used in said synonymic search query based at least in part on said weighting of said synonymic queries.

30. The computer-executable software code of claim 21 wherein said code for presenting a user-interface that enables a user to tune an amount of synonymic broadening comprises:
code for presenting a slide bar for progressively tuning the amount of synonymic broadening.

31. The computer-executable software code of claim 21 wherein said code for presenting a user-interface that enables a user to tune an amount of synonymic broadening comprises:
code for presenting a list of possible synonyms for at least one term of said input query; and
code for receiving a user's selection of at least one of said possible synonyms to be used in said generating said synonymic search query.

32. A system for generating a synonymic search query for searching for desired information from a corpus of information, said system comprising:
means for receiving a query for desired information;
means for determining at least one synonymic query that is synonymous in meaning with said received query;
means for receiving input tuning a number (Q) of synonymic queries to be included in a constructed synonymic search query; and
means for constructing a synonymic search query having Q number of synonymic queries.

33. The system of claim 32 wherein said means for constructing a synonymic search query comprises means for constructing a synonymic search query that comprises said received query and said Q number of synonymic queries.

34. The system of claim 32 further comprising:
means for determining the optimal Q synonymic queries to be included in said constructed synonymic search query.

35. The system of claim 34 wherein said means for determining the optimal Q synonymic queries further comprises:
means for weighting each of a plurality of synonymic queries based at least in part on determined co-occurrence of synonymic terms of said synonymic queries with corresponding terms of said received query in documents of said corpus of information.

36. A method for computerized searching for desired information from a corpus of information, the method comprising:
performing a synonymic search query for desired information from a corpus of information, said synonymic search query comprising a plurality of queries that are synonymous in meaning;
receiving identification of resulting documents responsive to each of said plurality of queries; and
ranking said received documents based at least in part on a weighting assigned to each of said plurality of queries.

37. The method of claim 36 further comprising:
receiving an input query; and
constructing said synonymic search query.

38. The method of claim 37 further comprising:
assigning a weighting to each of said plurality of queries, wherein the weighting assigned to each of said plurality of queries is based at least in part on co-occurrence of synonyms used in the query in place of corresponding terms of said input query with said corresponding terms of said input query in said corpus of information.

39. The method of claim 36 wherein said performing said synonymic search query comprises:
using a plurality of search engines to perform said plurality of queries in parallel.

40. The method of claim 36 further comprising:
presenting an identification of said resulting documents.

41. The method of claim 40 wherein said presenting of said resulting documents indicates the ranking of said resulting documents.

42. The method of claim 40 wherein said presenting comprises presenting organizing said resulting documents by query.

43. The method of claim 40 wherein said presenting comprises presenting an integrated list of said resulting documents from said plurality of queries, wherein each resulting document is identified once irrespective of the number of said plurality of queries that resulted in identification of the document being received.

44. The method of claim 40 wherein said presenting comprises presenting an identification of each of said resulting documents as a hyperlink to the corresponding identified document.

45. Computer-executable software code stored on a computer-readable medium, said computer-executable software code comprising:
code for performing a synonymic search query for desired information from a corpus of information, said synonymic search query comprising a plurality of queries that are synonymous in meaning; and
code for receiving identification of resulting documents responsive to each of said plurality of queries; and
code for ranking said received documents based at least in part on a weighting assigned to each of said plurality of queries.

46. The computer-executable software code of claim 45 further comprising:
code for receiving an input query; and
code for constructing said synonymic search query.

47. The computer-executable software code of claim 46 further comprising:
code for assigning a weighting to each of said plurality of queries, wherein the weighting assigned to each of said plurality of queries is based at least in part on co-occurrence of synonyms used in the query in place of corresponding terms of said input query with said corresponding terms of said input query in said corpus of information.

48. The computer-executable software code of claim 45 wherein said code for performing said synonymic search query comprises:
code for using a plurality of search engines to perform said plurality of queries in parallel.

49. The computer-executable software code of claim 45 further comprising:
code for presenting an identification of said resulting documents.

50. The computer-executable software code of claim 49 wherein said code for presenting comprises code for indicating the ranking of said resulting documents.
